(19) United States
(12) Patent Application Publication
(10) Pub. No.: US 2025/0386328 A1
(43) Pub. Date: Dec. 18, 2025

(54) PREDICTIVE PACKET DUPLICATION FOR WIRELESS COMMUNICATION

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US)

(21) Appl. No.: 18/745,881

(22) Filed: Jun. 17, 2024

(51) Int. Cl. H04W 72/04; H04L 1/08

(52) U.S. Cl. CPC H04W 72/04; H04L 1/08

(57) ABSTRACT

Methods, systems, and devices for wireless communications are described that provide for utilization of an artificial intelligence (AI) or machine learning (ML) model at a user equipment (UE) for control of protocol data unit (PDU) duplication at the UE. A network entity may configure the UE with multiple radio link control (RLC) legs, which may support duplicated instances of PDU transmissions, and allow the UE to use an AI/ML model to predictively perform duplication per PDU. The UE may select, using a packet duplication selection procedure (e.g., one or more AI/ML models) and based at least in part on one or more packet duplication parameters, one or more RLC legs for transmission of a PDU.

### FIELD OF TECHNOLOGY

The following relates to wireless communications, including predictive packet duplication for wireless communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support predictive packet duplication for wireless communication. For example, the described techniques provide for utilization of an artificial intelligence (AI) or machine learning (ML) model at a user equipment (UE) for control of protocol data unit (PDU) duplication at a UE. In some aspects, a network entity may configure the UE with multiple radio link control (RLC) legs, which may support duplicated instances of PDU transmissions, and allow the UE to use an AI/ML model to predictively perform duplication per PDU. For example, the network may configure one or more packet duplication parameters (e.g., one or more key performance indicators (KPIs) that the UE is to attempt to satisfy). The UE may select, using a packet duplication selection procedure (e.g., one or more AI/ML models) and based at least in part on the one or more packet duplication parameters, one or more RLC legs for transmission of a PDU. In some aspects, the UE may report duplication related behaviors as part of AI/ML logging/reporting to the network.

A method for wireless communication by a UE is described. The method may include receiving a message indicating one or more packet duplication parameters for one or more packets associated with a packet data convergence protocol (PDCP) layer of a protocol stack of the UE, selecting, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet, and transmitting the one or more instances of the first packet using the selected one or more radio link control legs.

A UE for wireless communication is described. The UE may include one or more memories storing processor executable code, and one or more processors coupled with the one or more memories. The one or more processors may individually or collectively be operable to execute the code to cause the UE to receive a message indicating one or more packet duplication parameters for one or more packets associated with a PDCP layer of a protocol stack of the UE, select, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet, and transmit the one or more instances of the first packet using the selected one or more radio link control legs.

Another UE for wireless communication is described. The UE may include means for receiving a message indicating one or more packet duplication parameters for one or more packets associated with a PDCP layer of a protocol stack of the UE, means for selecting, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet, and means for transmitting the one or more instances of the first packet using the selected one or more radio link control legs.

A non-transitory computer-readable medium storing code for wireless communication is described. The code may include instructions executable by one or more processors to receive a message indicating one or more packet duplication parameters for one or more packets associated with a PDCP layer of a protocol stack of the UE, select, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet, and transmit the one or more instances of the first packet using the selected one or more radio link control legs.

In some examples of the method, UEs, and non-transitory computer-readable medium described herein, the one or more packet duplication parameters include an identification of the set of multiple radio link control legs and an indication that the packet duplication selection procedure is to be used at the UE to select the one or more radio link control legs based on one or more predicted values associated with the one or more packet duplication parameters.

In some examples of the method, UEs, and non-transitory computer-readable medium described herein, the one or more packet duplication parameters include one or more performance metrics related to one or more of a predicted error rate associated with the first packet, a predicted latency associated with the first packet, an amount of usage of one or more radio link control legs associated with a duplicated instance of the first packet, or a limit on consecutive errors on the one or more radio link control legs.

Some examples of the method, UEs, and non-transitory computer-readable medium described herein may further include operations, features, means, or instructions for transmitting a duplication statistics report that includes one or more usage parameters associated with duplicated packets transmitted from the UE and utilization of one or more radio link control legs used for transmission of the duplicated packets. In some examples of the method, UEs, and non-transitory computer-readable medium described herein, the message further indicates whether packet duplication is enabled or disabled at the UE.

In some examples of the method, UEs, and non-transitory computer-readable medium described herein, the one or more radio link control legs include a primary radio link control leg and one or more secondary radio link control legs, and where a first instance of the first packet is transmitted on the primary radio link control leg and a second instance of the first packet is transmitted on a first radio link control leg that is selected from the one or more secondary radio link control legs based on the packet duplication selection procedure that indicates whether to duplicate the first packet, a number of instances of the first packet that is to be transmitted, and which of the one or more secondary radio link control legs to use for duplicate instances of the first packet.

In some examples of the method, UEs, and non-transitory computer-readable medium described herein, the packet duplication selection procedure outputs an indication of whether packet duplication of the one or more packets is enabled and an indication of the selected one or more radio link control legs, and where the indication is applied to all packets of the one or more packets or is applied on a per-packet basis for each of the one or more packets.

Some examples of the method, UEs, and non-transitory computer-readable medium described herein may further include operations, features, means, or instructions for providing, to a prediction model associated with the packet duplication selection procedure, one or more of a channel condition associated with a radio channel used for transmission of the one or more packets, a reliability target associated with the one or more packets, a latency target associated with the one or more packets, a state associated with traffic flow associated with the one or more packets, a state associated with the UE, or a usage limit for at least one of the set of multiple radio link control legs.

In some examples of the method, UEs, and non-transitory computer-readable medium described herein, the one or more packet duplication parameters include one or more of a latency target associated with the one or more packets, a reliability target associated with the one or more packets, or a throughput target associated with the one or more packets. Some examples of the method, UEs, and non-transitory computer-readable medium described herein may further include operations, features, means, or instructions for transmitting an indication of the selected one or more radio link control legs in one or more of a PDCP header provided with the first packet, a control packet associated with the first packet, or a duplication medium access control (MAC) control element.

Some examples of the method, UEs, and non-transitory computer-readable medium described herein may further include operations, features, means, or instructions for transmitting a PDCP duplication report that includes one or more of a log of radio link control legs used for transmission of the one or more packets, a log of failed packet transmissions, usage information for each of the one or more radio link control legs, an indication of a quantity of packets transmitted using two or more different duplication factors, an indication of one or more parameters that prompted transmission of at least two instances for at least one of the one or more packets, or performance statistics associated with one or more performance metrics.

Some examples of the method, UEs, and non-transitory computer-readable medium described herein may further include operations, features, means, or instructions for transmitting a capability message that provides an indication of a capability of the UE to perform the packet duplication selection procedure. In some examples of the method, UEs, and non-transitory computer-readable medium described herein, the receiving the message may include operations, features, means, or instructions for receiving a radio resource control configuration message that includes one or more key performance indicators (KPIs), performance targets, a link failure threshold parameter associated with the one or more radio link control legs, a usage threshold parameter associated with the one or more radio link control legs, or any combination thereof.

In some examples of the method, UEs, and non-transitory computer-readable medium described herein, the radio resource control configuration message further indicates one or more of whether to enable or disable usage of the packet duplication selection procedure, one or more quality of service (QOS) flows on which to enable or disable usage of the packet duplication selection procedure, a loss target over all radio link control legs, a quantity of consecutive errors associated with the one or more radio link control legs, a latency limit across the one or more radio link control legs, or any combination thereof.

Some examples of the method, UEs, and non-transitory computer-readable medium described herein may further include operations, features, means, or instructions for initiating a packet duplication fallback procedure based on a performance metric target associated with the packet duplication selection procedure being unmet, where the packet duplication fallback procedure includes one or more of performing packet duplication according to a fallback packet duplication state, transmitting a performance metric violation report as part of performance reporting, or discontinuing use of the packet duplication selection procedure for a radio bearer or packet flow associated with the one or more packets.

Some examples of the method, UEs, and non-transitory computer-readable medium described herein may further include operations, features, means, or instructions for receiving a medium access control (MAC) duplication message that indicates a set of radio link control legs to be used to transmit at least a second packet of the one or more packets and transmitting the second packet using the set of radio link control legs.

A method for wireless communication by a network entity is described. The method may include transmitting, to a UE, a message indicating one or more packet duplication parameters for one or more packets associated with a PDCP layer of a protocol stack of the UE, the one or more packet duplication parameters indicating that a packet duplication selection procedure is to be used at the UE for selection of one or more radio link control legs of a set of multiple radio link control legs at the UE for transmission of the one or more packets and obtaining, from the UE, one or more instances of at least a first packet of the one or more packets.

A network entity for wireless communication is described. The network entity may include one or more memories storing processor executable code, and one or more processors coupled with the one or more memories. The one or more processors may individually or collectively be operable to execute the code to cause the network entity to transmit, to a UE, a message indicating one or more packet duplication parameters for one or more packets associated with a PDCP layer of a protocol stack of the UE, the one or more packet duplication parameters indicating that a packet duplication selection procedure is to be used at the UE for selection of one or more radio link control legs of a set of multiple radio link control legs at the UE for transmission of the one or more packets and obtain, from the UE, one or more instances of at least a first packet of the one or more packets.

Another network entity for wireless communication is described. The network entity may include means for transmitting, to a UE, a message indicating one or more packet duplication parameters for one or more packets associated with a PDCP layer of a protocol stack of the UE, the one or more packet duplication parameters indicating that a packet duplication selection procedure is to be used at the UE for selection of one or more radio link control legs of a set of multiple radio link control legs at the UE for transmission of the one or more packets and means for obtaining, from the UE, one or more instances of at least a first packet of the one or more packets.

A non-transitory computer-readable medium storing code for wireless communication is described. The code may include instructions executable by one or more processors to transmit, to a UE, a message indicating one or more packet duplication parameters for one or more packets associated with a PDCP layer of a protocol stack of the UE, the one or more packet duplication parameters indicating that a packet duplication selection procedure is to be used at the UE for selection of one or more radio link control legs of a set of multiple radio link control legs at the UE for transmission of the one or more packets and obtain, from the UE, one or more instances of at least a first packet of the one or more packets.

In some examples of the method, network entities, and non-transitory computer-readable medium described herein, the one or more packet duplication parameters include an identification of the set of multiple radio link control legs and an indication that the packet duplication selection procedure is to be used at the UE to select the one or more radio link control legs based on one or more predicted values associated with the one or more packet duplication parameters.

In some examples of the method, network entities, and non-transitory computer-readable medium described herein, the one or more packet duplication parameters include one or more performance metrics related to one or more of a predicted error rate associated with the first packet, a predicted latency associated with the first packet, an amount of usage of one or more radio link control legs associated with a duplicated instance of the first packet, or a limit on consecutive errors on the one or more radio link control legs.

Some examples of the method, network entities, and non-transitory computer-readable medium described herein may further include operations, features, means, or instructions for obtaining, from the UE, a duplication statistics report that includes one or more usage parameters associated with duplicated packets transmitted from the UE and utilization of one or more radio link control legs used for transmission of the duplicated packets. In some examples of the method, network entities, and non-transitory computer-readable medium described herein, the message further indicates whether packet duplication is enabled or disabled at the UE.

In some examples of the method, network entities, and non-transitory computer-readable medium described herein, the one or more radio link control legs include a primary radio link control leg and one or more secondary radio link control legs, and where a first instance of the first packet is transmitted on the primary radio link control leg and a second instance of the first packet is transmitted on a first radio link control leg that is selected from the one or more secondary radio link control legs based on the packet duplication selection procedure that indicates whether to duplicate the first packet, a number of instances of the first packet that are to be transmitted, and which of the one or more secondary radio link control legs to use for duplicate instances of the first packet. In some examples of the method, network entities, and non-transitory computer-readable medium described herein, the packet duplication parameters configure the packet duplication selection procedure to output an indication of whether packet duplication of the one or more packets is enabled and an indication of the selected one or more radio link control legs, and where the indication is applied to all packets of the one or more packets or is applied on a per-packet basis for each of the one or more packets.

In some examples of the method, network entities, and non-transitory computer-readable medium described herein, the packet duplication parameters configure a prediction model associated with the packet duplication selection procedure, and where inputs to the prediction model include one or more of a channel condition associated with a radio channel used for transmission of the one or more packets, a reliability target associated with the one or more packets, a latency target associated with the one or more packets, a state associated with traffic flow associated with the one or more packets, a state associated with the UE, or a usage limit for at least one of the set of multiple radio link control legs.

Some examples of the method, network entities, and non-transitory computer-readable medium described herein may further include operations, features, means, or instructions for obtaining an indication from the UE of a quantity of instances of the first packet that are transmitted, where the indication is received in one or more of a PDCP header provided with an initial instance the first packet, a control packet associated with the first packet, or a duplication MAC control element.

Some examples of the method, network entities, and non-transitory computer-readable medium described herein may further include operations, features, means, or instructions for obtaining a PDCP duplication report from the UE that includes one or more of a log of radio link control legs used for transmission of the one or more packets, a log of failed packet transmissions, usage information for each of the one or more radio link control legs, an indication of a quantity of packets transmitted using two or more different duplication factors, an indication of one or more parameters that prompted transmission of at least two instances for at least one of the one or more packets, or performance statistics associated with one or more performance metrics.

Some examples of the method, network entities, and non-transitory computer-readable medium described herein may further include operations, features, means, or instructions for obtaining a capability message from the UE that provides an indication of a capability of the UE to perform the packet duplication selection procedure, and where the one or more packet duplication parameters are selected based on the capability of the UE to perform the packet duplication selection procedure.

In some examples of the method, network entities, and non-transitory computer-readable medium described herein, the transmitting the message may include operations, features, means, or instructions for outputting a radio resource control configuration message that includes one or more key performance indicators (KPIs), performance targets, a link failure threshold parameter associated with the one or more radio link control legs, a usage threshold parameter associated with the one or more radio link control legs, or any combination thereof.

Some examples of the method, network entities, and non-transitory computer-readable medium described herein may further include operations, features, means, or instructions for configuring the UE with a packet duplication fallback procedure that is to be initiated based on a performance metric target associated with the packet duplication selection procedure being unmet, where the packet duplication fallback procedure includes one or more of performing packet duplication according to a fallback packet duplication state, transmitting a performance metric violation report as part of performance reporting, or discontinuing use of the packet duplication selection procedure for a radio bearer or packet flow associated with the one or more packets.

Some examples of the method, network entities, and non-transitory computer-readable medium described herein may further include operations, features, means, or instructions for outputting a MAC duplication message to the UE that indicates a set of radio link control legs to be used to transmit at least a second packet of the one or more packets and obtaining one or more instances of the second packet in accordance with the MAC duplication message.

### BRIEF DESCRIPTION OF THE DRAWINGS

FIG. 1 shows an example of a wireless communications system that supports predictive packet duplication for wireless communication in accordance with one or more aspects of the present disclosure.

FIG. 2 shows an example of a wireless communications system that supports predictive packet duplication for wireless communication in accordance with one or more aspects of the present disclosure.

FIG. 3 shows an example of a process flow that supports predictive packet duplication for wireless communication in accordance with one or more aspects of the present disclosure.

FIG. 4 shows an example of a machine learning (ML) architecture that supports predictive packet duplication for wireless communication in accordance with one or more aspects of the present disclosure.

FIGS. 5 and 6 show examples of block diagrams of a user equipment (UE) that supports predictive packet duplication for wireless communication in accordance with one or more aspects of the present disclosure.

FIGS. 7 through 13 show examples of process flows that support predictive packet duplication for wireless communication in accordance with one or more aspects of the present disclosure.

FIG. 14 is an illustrative block diagram of an example ML architecture that may be used for wireless communications in accordance with one or more aspects of the present disclosure.

FIGS. 15 and 16 show block diagrams of devices that support predictive packet duplication for wireless communication in accordance with one or more aspects of the present disclosure.

FIG. 17 shows a block diagram of a communications manager that supports predictive packet duplication for wireless communication in accordance with one or more aspects of the present disclosure.

FIG. 18 shows a diagram of a system including a device that supports predictive packet duplication for wireless communication in accordance with one or more aspects of the present disclosure.

FIGS. 19 and 20 show block diagrams of devices that support predictive packet duplication for wireless communication in accordance with one or more aspects of the present disclosure.

FIG. 21 shows a block diagram of a communications manager that supports predictive packet duplication for wireless communication in accordance with one or more aspects of the present disclosure.

FIG. 22 shows a diagram of a system including a device that supports predictive packet duplication for wireless communication in accordance with one or more aspects of the present disclosure.

FIGS. 23 through 28 show flowcharts illustrating methods that support predictive packet duplication for wireless communication in accordance with one or more aspects of the present disclosure.

### DETAILED DESCRIPTION

A wireless device may be equipped with a protocol stack to support various functionalities associated with wireless communication. The protocol stack may include various protocol layers. One example of a protocol layer includes a radio link control (RLC) layer (also referred to as an RLC entity herein). The RLC layer may perform transfer of upper layer protocol data units (PDUs) according to one or more modes, including: an acknowledged mode (AM), an unacknowledged mode (UM), and a transparent mode (TM). The RLC layer may receive an RLC data PDU from and/or transmit to upper protocol layers of the protocol stack of the wireless device. In some cases, a wireless device (e.g., a user equipment (UE)) may be configured transmit duplicated PDUs over two paths corresponding to different radio link control (RLC) entities (also referred to as RLC legs herein) of a packet data convergence protocol (PDCP) layer, in order to enhance reliability. In some deployments, such duplication may be configured by the network and applied for all PDU transmissions associated with a data flow (e.g., a quality of service (QOS) flow) at the wireless device. In some cases, such configuration may be applied by the network only after packet loss of some packets, which may lead to increased latency. Further, such configured PDU duplication is applied until the configuration is changed again by the network, which can consume additional wireless resources and processing resources of the wireless device even in cases where the duplication is not likely to enhance successful PDU reception. Additionally, existing mechanisms are in place may allow a UE to cancel a duplicated transmission if an acknowledgment of a PDU is received, but such an acknowledgment is likely to be received only after one or more duplicated instances of a PDU have already been provided to a different RLC leg used to transmit the duplicated instance of the PDU, and thus such mechanisms may not substantially reduce transmission of duplicated instances of a PDU.

In accordance with various aspect discussed herein, a wireless device may perform predictive packet duplication based on one or more parameters that are measured by a transmitting device (e.g., a UE). In some aspects, a wireless device may utilize an artificial intelligence (AI) or machine learning (ML) model for enhanced control of PDU duplication. In some aspects, a network entity may configure two or more RLC legs to be available for duplication, and allow a UE to use an AI/ML model to predictively perform duplication per PDU (e.g., on a per-PDU basis). For example, a network entity may configure a set of key performance indicators (KPIs) that the UE is to attempt to satisfy (e.g., in terms of one or more of error, latency, limits to channel utilization, and the like). In some aspects, a UE may run a prediction model based on the configured KPIs to determine whether to duplicate PDUs and, if so, which RLC legs to use for PDU transmission. The output of the prediction model may be the decision to duplicate PDUs across RLC legs, which can be a semi-static toggle of (e.g., ON/OFF duplication+selection of RLC legs) or can be a per-PDU decision. The input to the prediction model may include radio conditions measured at the UE (e.g., RSRP, CQI, RLC loss, HARQ failure rate, HARQ RTT, etc.), QoS flow/KPI state (e.g., prediction of UE traffic importance, or previous losses or likelihood of transmit success), UE state (e.g., memory consideration, UE power, availability of grants, etc.), and/or performance targets configured by the network (e.g. certain latency/reliability/throughput targets) or some internal objective of the UE. In some aspects, the UE may report duplication related behaviors as part of AI/ML logging/reporting provided to a network entity. Additionally, in some aspects, UEs may provide capability messaging that indicates UE AI/ML capabilities for duplication prediction, and radio resource control (RRC) signaling may be used to enable or configure one or more AI/ML models for determination of PDU duplication.

By enabling the wireless device to support determination of whether or not to perform duplication of RLC data PDUs, or selection of RLC legs for transmission of data PDUs, according to the learning model (e.g., an AI/ML model), the wireless device may mitigate unnecessary retransmissions of RLC data PDUs, and may prevent reordering delays associated with RLC data PDUs, among other examples as described herein. It should be understood that other models or data structures (e.g., tables) may be used for supporting and enabling the wireless device (e.g., an RLC layer of the wireless device) to support processing (e.g., duplication determination, RLC leg selection) of RLC data PDUs as described herein.

Aspects of the disclosure are initially described in the context of wireless communications systems. Aspects of the disclosure are further illustrated by and described with reference to apparatus diagrams, process flows, system diagrams, and flowcharts that relate to predictive packet duplication for wireless communication.

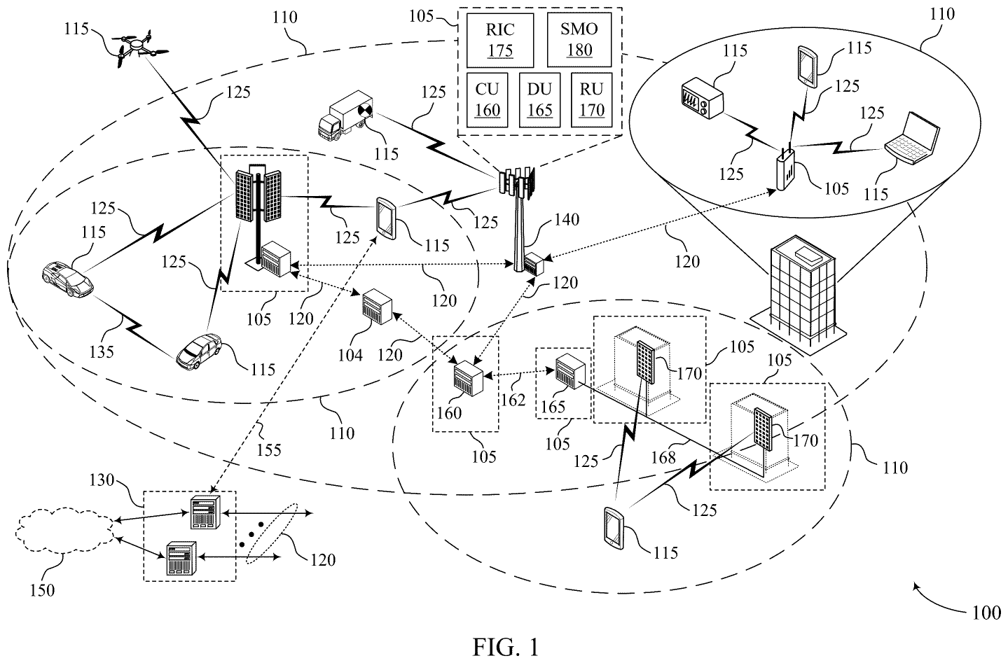

FIG. 1 shows an example of a wireless communications system 100 that supports predictive packet duplication for wireless communication in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of

T_{S}=1/(Δfₘₐₓ·N_{f})seconds,

for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a UE 115 (e.g., a PDCP layer of the UE 115) may experience inefficiencies or latencies based on PDU duplication across two or more RLC legs. In some aspects, a UE 115 may use an AI/ML model for control of PDU duplication. For example, a network entity 105 may configure a UE 115 with multiple RLC legs, which may support duplicated instances of PDU transmissions, and allow the UE 115 to use an AI/ML model to predictively perform duplication per PDU. In some aspects, the network entity 105 may configure one or more packet duplication parameters (e.g., one or more KPIs), and the UE 115 may select, using a packet duplication selection procedure (e.g., one or more AI/ML models) and based at least in part on the one or more packet duplication parameters, one or more RLC legs for transmission of a PDU.

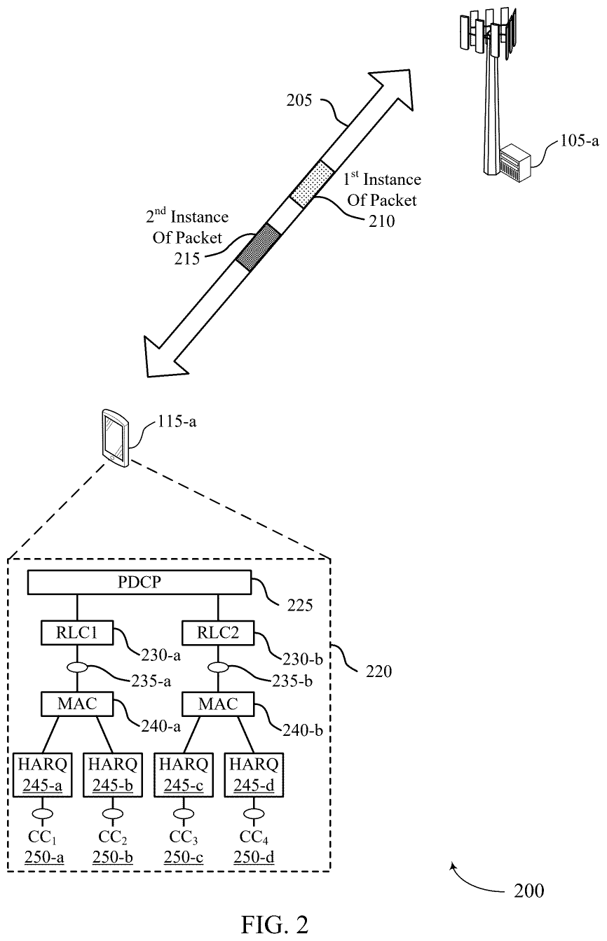

FIG. 2 shows an example of a wireless communications system 200 that supports predictive packet duplication for wireless communication in accordance with one or more aspects of the present disclosure. The wireless communications system 200 may implement or be implemented by aspects of the wireless communications system 100 as described herein with reference to FIG. 1. For example, the wireless communications system 200 may include a UE 115-a and a network entity 105-a, which may be an example of UEs 115 and network entities 105 as described herein with reference to FIG. 1. The wireless communications system 200 may support 3G, 4G, 5G, or radio access technologies beyond 5G.

The UE 115-a and the network entity 105-a may perform wireless communication (e.g., one or more of receiving, obtaining, transmitting, or outputting one or more of control information, configuration information, or data) via a communication link 205, which may be examples of communications links 125 as described herein with reference to FIG. 1. In some cases, communication link 205 may include multiple component carriers. In the example of FIG. 2, the UE 115-a may be configured to perform packet duplication, and may transmit a first instance of a packet 210 and a second instance of the packet 215 via communication link 205 (e.g., using different RLC legs at the UE 115-a). In this example, UE 115-a may be equipped (e.g., configured) with at least one protocol stack 220 to support one or more of receiving, obtaining, transmitting, or outputting one or more of control information or data. The protocol stack 220 may include one or more protocol layers, which may be ordered in a hierarchical architecture. In some examples, the protocol stack 220 may be associated with one or more of a control plane (and may be referred to as a control plane protocol stack) or a user plane (and may be referred to as a user plane protocol stack). The protocol stack 220 may include multiple layers, including illustrated layers of this example which include a PDCP layer 225, an RLC layer or entity 230, and a MAC layer that provides MAC entities 240. In this example, two RLC legs are illustrated, including a first RLC leg that includes a first RLC instance 230-a associated with a first logical channel 235-a, a first MAC entity 240-a, a first HARQ entity 245-a associated with a first component carrier 250-a and a second HARQ entity 245-b associated with a second component carrier 250-b. Similarly, a second RLC leg includes a second RLC instance 230-b associated with a second logical channel 235-b, a second MAC entity 240-b, a third HARQ entity 245-c associated with a third component carrier 250-c and a fourth HARQ entity 245-d associated with a fourth component carrier 250-d.

The RRC layer or entity 230 may be capable of, configured to, or operable to support establishment, configuration, and maintenance of a connection between the UE 115-a and the network entity 105-a supporting radio bearers for user plane data. Additionally, the RRC layer or entity 230 may be capable of, configured to, or operable to support establishment, configuration, and maintenance of a connection between a network entity 105 or a core network supporting radio bearers for user plane data as described herein with reference to FIG. 1. The PDCP layer 225 may be capable of, configured to, or operable to support header compression, in-sequence delivery, ciphering and integrity protection, transfer of user plane and control plane data, removal of duplicates. Additionally, or alternatively, PDCP layer 225 may be capable of, configured to, or operable to support routing of duplicated PDUs.

The RLC layer or entity 230 may be capable of, configured to, or operable to support transfer of upper layer PDUs according one or more modes, including: AM, UM, and TM. The RLC layer or entity 230 may perform error correction through ARQ, concatenation, segmentation, and reassembly of RLC SDUs, re-segmentation of RLC data PDUs, reordering of RLC data PDUs, duplicate detection, RLC re-establishment and protocol error detection and recovery. The MAC layer or entity 240 may be capable of, configured to, or operable to support priority handling and multiplexing of logical channels into transport channels. Additionally, the MAC layer or entity 240 may be capable of, configured to, or operable to support error detection techniques, error correction techniques, or both to support retransmissions to improve link efficiency.

In accordance with various aspects, the UE 115-a may be configured for PDCP duplication, which may provide enhanced reliability for wireless communications. In some cases, UE 115-a may be configured (e.g., via RRC) for PDCP duplication for a data radio bearer (DRB) and may establish RLC entities 230 for duplication. In some cases, for resource blocks (RBs) configured with PDCP duplication, each PDCP entity at PDCP layer 225 may be associated with N UM RLC entities (for same direction), 2×N UM RLC entities (N for each direction), or N AM RLC entities, where 2<=N<=4. When duplication is activated, the original PDCP PDU and the corresponding duplicate(s) may be transmitted on different carriers 250. The logical channels of a radio bearer configured with duplication may either belong to a same MAC entity 240 at the MAC layer (e.g., referred to as carrier aggregation (CA) duplication) or to different MAC entities 240 at the MAC layer (e.g., referred to as dual connectivity (DC) duplication). CA duplication may also be configured in either or both of the MAC entities together with DC duplication when duplication over more than two RLC entities is configured for the radio bearer. In CA duplication, logical channel 235 mapping restrictions may be used in a MAC entity to provide that the different logical channels of a radio bearer in the MAC entity are not sent on the same carrier. In some cases, the logical channel mapping restrictions of the logical channels 235 of the DRB may be lifted for as long as CA duplication remains deactivated for the DRB in the MAC entity. In some cases, when an RLC entity 230 acknowledges the transmission of a PDCP PDU, the PDCP entity may indicate to the other RLC entity 230 to discard it.

In some aspects, a semi-static duplication may be configured through a PDCP configuration provided in a duplication RLC activation or deactivation MAC control element (MAC-CE). In some cases, a survival time configuration may be provided (e.g., in a PDCP-configuration parameter survivalTimeStateSupport-r17 ENUMERATED {true}). Such a survival time configuration may indicate whether the DRB associated with this PDCP entity has survival time state support. If this field is configured to be true, all associated RLC entities are activated for PDCP duplication upon reception of a retransmission grant, and a retransmission grant received on a carrier group used for a bearer that supports survival time is used as an implicit trigger for PDCP duplication.

As discussed, prior PDCP duplication frameworks are reactive in nature, where the network activates or deactivates duplication based on losses that are observed by the network. In such deployments, by the time the network activates duplication, it is likely that some loss may have occurred. Thus, such techniques may be wasteful in terms of resources, and even if the UE 115-a knows a PDCP PDU has very high probability of success at one RLC leg, UE 115-a must submit PDUs to all RLC legs. After RLC acknowledgment for RLC AM, the PDCP may discard it on other RLC legs, however, in many cases duplicated traffic is low-latency and by the time such an acknowledgment is received on one leg, other legs likely would have transmitted the PDU, which means they cannot discard and must persist until successful delivery. Further, in cases where RLC UM is used, there may be no mitigation for such wastefulness of resources. Additionally, the static or semi-static nature of such duplication configuration may also result in relatively slow changes to the configuration. Various aspects as discussed herein may provide for reduced waste of wireless resources through context awareness at the UE 115-a to provide proactive and dynamic duplication of PDUs.

In some aspects, the UE 115-a may be configured to make per-PDU PDCP duplication decisions based on AI/ML model as well as information available to the UE 115-a (e.g., radio conditions, likelihood of success on each leg, flow state, or any combination thereof). In some aspects, the network entity 105-a may configure two or more duplication legs, and allow the UE 115-a to use one or multiple AI/ML models to predictively perform duplication of PDUs. In some cases, the network entity 105-a may configure one or more KPIs that the UE is requested to satisfy. For example, KPIs may be provided in terms of error, latency, and limits to channel utilization (e.g., the network entity 105-a requests UE 115-a to perform duplication but restricts usage of secondary RLC legs to 10% such that the UE 115-a may use one or more secondary legs to 10% of the load over long-term). In some aspects, the KPIs may also provide for a survival time use case. In some aspects, the network entity 105-a may use existing techniques to enable and disable duplication, with UE 115-a decisions related to such duplication configured as part of enabling duplication. Additionally, in some cases, the UE 115-a may report duplication related behaviors as part of AI/ML logging and reporting. In some aspects, the UE 115-a may use one or more secondary RLC legs for duplication, and the UE 115-a may select a favorable RLC leg based on a current state of conditions.

In accordance with various aspects, usage of one or more AI/ML models at the UE 115-a may provide a proactive decision related to duplication, which may be an example of a packet duplication selection procedure, where information available to the UE 115-a may be leveraged to determine duplication (e.g., the UE 115-a may duplicate PDUs after a first HARQ failure or a HARQ second failure), where a trigger for the duplication is determined by an AI/ML model that may be tuned to the configured KPI versus one of a relatively large quantity of potential RRC-configured options. In some aspects, for the survival time use case, the UE 115-a may follow one or more strategies to ensure survival time satisfaction, such as through duplication of every other PDU, duplication based on HARQ feedback for dynamic grant (or configured grant) resource allocations, for example. In some aspects, a set of current conditions may be provided to one or more AI/ML models at the UE 115-a as a model input, and an output of the one or more AI/ML models may be a decision to duplicate PDUs across RLC legs. In some cases, duplication may be initiated according to a semi-static toggle (e.g., ON/OFF duplication and selection of RLC legs) or can be a per-PDU decision to duplicate. In some aspects, one or more thresholds may be used to determine whether to duplicate or not. In other aspects, a more complex input-output mapping function may be used, such as an input of radio conditions (e.g., reference signal received power (RSRP), channel quality indictor (CQI), RLC loss, HARQ failure rate, HARQ round trip time (RTT), and the like), a QoS flow or KPI state (e.g., a prediction of UE traffic importance, or previous losses or likelihood of transmission success), a UE 115-a state (e.g., memory consideration, UE power, availability of grants, and the like), or any combination thereof. In some aspects, one or more performance targets or KPIs may be provided by the network entity 105-a, such as a latency target, a reliability target, a throughput target, or any combination thereof. Additionally, or alternatively, the UE 115-a may use an internal objective of the UE as a KPI. In some aspects, the UE 115-a may be configured with one or more constraints on duplication behavior. For example, such constraints may be provided by the network entity 105-a, such as a range or a target on RLC usage.

In some aspects, the UE 115-a may inform the network entity 105-a of duplication states by indicating which other RLC legs carry duplicates of the PDU in the PDCP header. In some cases, the UE 115-a may use a forward control PDCP PDU that indicates activation of duplication or RLC switch. Alternatively, this may be an uplink duplication MAC CE. In some cases, the UE 115-a may provide a recommendation to the network entity 105-a, or provide a notice of the behavior the UE 115-a has already adopted.

In some aspects, the UE 115-a may provide information to the network entity 105-a that indicates parameters that resulted in changes in duplication or RLC leg selection. In some cases, one or more information elements (IEs) may be used to support reporting associated with the AI/ML model (which may include labels such as meta data, timestamps, etc.). In some cases, the network may build and monitor AI/ML models that can provide the efficient duplication behavior for PDCP. In some cases, the model input may include KPI targets in terms of reliability, latency, secondary RLC usage limit, Radio conditions, or any combination thereof. Further, the model output may include conditions under which the UE 115-a enables or disables duplication (e.g., semi-static switching), or may include one or more RLCs that are to carry each PDCP PDU (e.g., the model determines routing and duplication on a per-PDU basis). In some cases, the UE 115-a may provide log information, where the UE 115-a may log information and share it an AI/ML server at the network. For example, the UE 115-a may log all PDCP PDUs and the RLC legs used to transmit them, along with any failed PDUs. Additionally, or alternatively, the UE 115-a may provide statistics on RLC usage per leg, a percent of duplicated PDUs along with a number of duplications of each. In some cases, if the UE 115-a is switching duplication on and off, it can log the information that leads to switching, such as, for example, radio measurements on RLC legs, error or latency on each leg, survival time considerations, or any combination thereof. In some cases, the UE 115-a may report KPI performance in terms of acknowledgment/negative-acknowledgment on different HARQ or RLC legs in duplication.

In some aspects, additionally, or alternatively, the UE 115-a may provide a capability report to the network entity 105-a. In some cases, the capability report may provide an indication of a capability to perform autonomous duplication at the UE 115-a based on one or more AI/ML models, as well as quantity of supported RLC legs. In some cases, the capability report may also indicate an ability of the UE 115-a to support certain latency or reliability/throughput targets under certain radio conditions. Additionally, or alternatively, the capability report may indicate an AI/ML model score that indicates tested performance or AI native performance of the duplication feature.

In some aspects, the UE 115-a may be configured for PDCP duplication by the network entity 105-a. In some cases, the configuration may be provided by, at least in part, RRC configuration information. For example, RRC configuration IEs may be provided that indicate controls for AI/ML PDCP duplication that, for example, indicate bounds or UE 115-a duplication behavior, as well as one or more KPIs that the UE 115-a should try to satisfy. For example, an example of an RRC IE may be as follows:

drb:= SEQUENCE {

| | |
|---|---|
| pdcp-Duplication | BOOLEAN |

```
      RLC-legs SEQUENCE {RLC-leg, duplicationState}
    Primary-RLC-leg ENUMERATED{ RLC-leg} OPTIONAL
  RLF-Threshold ENUMERATED { }
  RLC-Leg-Usage SEQUENCE { SEQUENCE{RLC-leg,
  allowed-Usage}}
  PDCP-loss-target ENUMERATED{ }
  Consecutive-Errors-Allowed ENUMERATED{ }
  Allowed-latency-across-legs ENUMERATED{ }
```

| | |
|---|---|
| AIML_Allowed | ENUMERATED {Allowed, Not Allowed} |

QoSFlowsAllowed SEQUENCE {QoS flows indexes}
}

where the parameters and associated description are listed in Table 1, below.

TABLE 1

| Parameter | Description |
|---|---|
| pdcp-Duplication | Legacy parameter indicating duplication is |
| | configured |
| RLC-legs | RLC legs configured with duplication along with |
| | initial duplication state |
| Primary-RLC-leg | Optional parameter indicating if UE should be |
| | transmitting on a primary leg and using other legs |
| | only for duplication. Absence of this |
| | parameter indicates a UE can use any leg as |
| | the primary leg for any PDU |
| RLF-Threshold | For RLC AM mode, the RLF-threshold parameter |
| | may be configured to declare RLF for total loss |
| | over all legs. This is different from prior |
| | deployments where RLF is only assessed on |
| | primary leg and RLF declared even if secondary |
| | legs are good |
| RLC-Leg-Usage | KPI to limit a number of packets a UE can |
| | duplicate over any RLC leg. This can be a |
| | percentage limit, or amount of total bytes |
| | over an assessment time configured |
| PDCP-loss-target | A loss KPI the UE fulfills through duplication |
| | strategy, this can also be generalized to |
| | RLC loss target |
| Consecutive-Errors- | For the survival time use case, this is the |
| Allowed | amount of consecutive errors allowed. This |
| | can be used to dynamically switch on and off |
| | duplication |
| Allowed-latency- | When duplicating, this is the amount of latency |
| across-legs | between duplicated transmissions in ms the |
| | UE should target. This can be used to |
| | determine if UE may use HARQ feedback to trigger |
| | duplication for a more efficient procedure |
| AIML_Allowed | Whether AIML behavior is allowed |
| QoSFlowsAllowed | Indicates whether this AIML behavior is applicable |
| | only for some QoS flows |

In some aspects, in the event that the UE 115-a is not able to fulfill one or more configured KPIs (e.g., with respect to loss, consecutive loss, latency, RLC leg usage, and the like), the UE 115-a may be configured with some fallback behavior. For example, the UE 115-a may be configured to fall back to initially configured duplication-state (e.g., duplication that is not based on output of an AI/ML model or predictive aspects as discussed herein. In another example, the UE 115-a may transmit a KPI violation report to the network entity 105-a or to an AI/ML server via the network entity 105-a. In a further example, the UE may disable the AI/ML behavior for the bearer or QoS flow associated with the KPI violation. In some aspects, a MAC-CE may be defined that indicates PDCP duplication activation or deactivation, and may be used to signal a certain duplication behavior at the UE (e.g., which RLC legs to use). Such a MAC-CE may provide the network entity 105-a with the ability to override UE 115-a behavior.

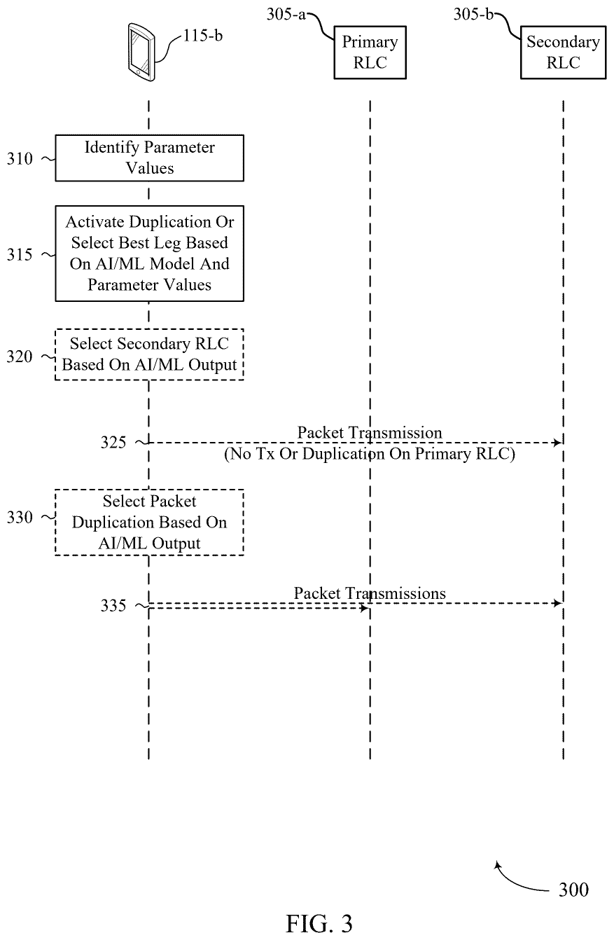

FIG. 3 shows an example of a process flow 300 that supports predictive packet duplication for wireless communication in accordance with one or more aspects of the present disclosure. The process flow 300 may implement aspects of the wireless communications systems 100 or 200 as described with reference to FIGS. 1 and 2. The process flow 300 may include a UE 115-b, a primary RLC entity 305-a, and a secondary RLC entity 305-b, which may be examples of UEs 115 and RLC entities 230 as described herein. In the following description of the process flow 300, the operations between the UE 115-b and the RLC entities 305 may be performed in a different order than the example order shown, or the operations performed by the UE 115-b may be performed in different orders or at different times. Some operations may also be omitted from the process flow 300, and other operations may be added to the process flow 300. In the present disclosure, RLC entities 305 refers to RLC entities 305-a and 305-b depicted in FIG. 3.

At 310, the UE 115-b may identify one or more parameter values associated with packet duplication. In some examples, the parameter values may include one or more channel measurements made by the UE 115-b (e.g., RSRP, CQI, RLC loss, HARQ failure rate, HARQ RTT, or any combination thereof). In some cases, the parameter values may include a QoS flow/KPI state (e.g., prediction of UE traffic importance, or previous losses or likelihood of transmit success), a UE 115-b state (e.g., memory consideration, UE power, availability of grants, etc.), and/or performance targets configured by the network (e.g., certain latency/reliability/throughput targets), some internal objective of the UE, or any combination thereof.

At 315, the UE 115-b may activate duplication or select a preferred RLC leg based on an output of an AI/ML model and one or more of the parameter values. As discussed herein, in some aspects the UE 115-b may provide one or more of the parameter values as an input to a predictive model (e.g., one or more AI/ML models), and the output of the model may indicate whether to use packet duplication of a PDCP PDU, or may indicate a preferred RLC leg (e.g., based on a higher likelihood of successfully transmitting using a certain component carrier). For example, a packet duplication selection procedure may be used to select whether to use packet duplication and one or more RLC legs that may be used to transmit one or more instances of a packet. In some examples, if a parameter value is within a first range (e.g., a channel condition associated with a first RLC leg is within a first range that indicates a lower likelihood of successful transmissions), duplication may be activated, RLC leg selection may be activated, or both, and if the parameter value is within a second range (e.g., that indicates higher likelihood of successful transmissions), duplication, RLC leg selection, or both, may not be activated or may be deactivated. In some cases, a predictive model associated with a packet duplication selection procedure may determine a number of instances of a packet that are to be transmitted (e.g., multiple instances of a packet may be transmitted based on one or more parameters that are associated with relatively poor channel conditions, and the quantity of instances may be reduced when the one or more parameters are associated with relatively better channel conditions). In some cases, a predictive model associated with a packet duplication selection procedure may consider a combination of parameter values to make a decision.

In some cases, at 320, the UE 115-b may select a second RLC leg based on the predictive model output (e.g., AI/ML output). In such cases, the predictive model (e.g., a model associated with the packet duplication selection procedure) may be used to identify a RLC leg of multiple available RLC legs that has a relatively high likelihood of successfully transmitting the PDCP PDU. For example, if a parameter value (e.g., a channel condition associated with a first RLC leg) is greater than or equal to a threshold value (e.g., a threshold RSRP value), a first RLC leg may be used, and if the parameter is less than the threshold value a second RLC leg may be used. In some cases, the predictive model may consider a combination of parameter values to make a decision.

In the example of FIG. 3, the AI/ML model may indicate that the secondary RLC entity 305-b is to be used for a transmission and, as indicated at 325, the UE 115-b may transmit the packet using only the identified secondary RLC entity 305-b leg.

In some cases, at 330, the UE 115-b may select packet duplication based on the predictive model output (e.g., AI/ML output). In such cases, the predictive model (e.g., a model associated with the packet duplication selection procedure) may be used to determine whether to duplicate a PDU/packet or not. For example, if a parameter value (e.g., a channel condition associated with a radio channel used for transmission of the one or more packets) is greater than or equal to a threshold value (e.g., a threshold RSRP value), packet duplication may not be used, and if the parameter is less than the threshold value (e.g., the channel condition is less than the threshold RSRP value) packet duplication may be used. In some cases, the predictive model may consider a combination of parameter values to make a decision. In some aspects, such a determination may be made on a per-PDU basis. In other aspects, such a determination may be a semi-static determination and the UE 115-b may continue to operate in accordance with the determination (e.g., duplicating packets or no longer duplicating packets) until a subsequent determination changes the UE 115-b behavior. In the example of FIG. 3, the AI/ML model may indicate that the PDCP PDU is to be duplicated across the primary RLC entity 305-a and the secondary RLC entity 305-b and, at 335, the UE 115-b may transmit the PDCP PDU packet using both the primary RLC entity 305-a and the secondary RLC entity 305-b.

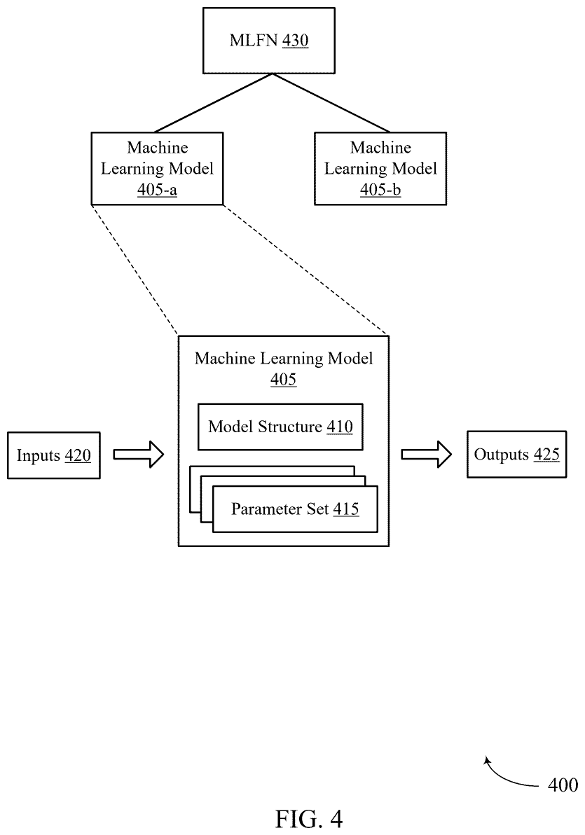

As discussed, various aspects describe techniques in which one or more predictive models (e.g., AI/ML models) may be used to determine whether a UE 115 is to duplicate packets, may be used to identify a RLC leg for a packet transmission, or both. FIGS. 4 through 14 describe various aspects of predictive models that may be used in accordance with the packet duplication techniques of various aspects.

FIG. 4 shows an example of a ML architecture 400 that supports predictive packet duplication for wireless communication in accordance with one or more aspects of the present disclosure. The machine learning architecture 400 illustrates an implementation for machine learning models 405 (e.g., artificial intelligence models), which may be used to perform one or more of the features described herein.

A machine learning model 405 may generate a set of one or more outputs 425 based on a set of one or more inputs 420. For example, the machine learning model 405 may be a data driven model (e.g., algorithm), which uses machine learning techniques (e.g., artificial intelligence techniques) to generate the outputs 425. In some cases, the machine learning model 405 may be described using a model structure 410. For example, the machine learning model 405 may include one or more computation graphs, and the model structure 410 may define a structure for the machine learning model 405 for generating the outputs 425. In some examples, the machine learning model 405 may include one or more parameter sets 415. The parameter sets 415 may be neural network weights, for example, which may be used in combination with the model structure 410 to generate the outputs 425. In some examples, the machine learning model 405 (e.g., alone or in combination with other machine learning models 405) may implement a machine learning function (e.g., an artificial intelligence function) which may generate the outputs 425 based on the inputs 420.

In some examples, a machine learning feature name (MLFN) 430 may be used to identify a function performed by one or more machine learning models 405. For example, the MLFN 430 may correspond to CSI feedback, beam management, positioning, KPI management, or other functionalities. In some cases, the one or more machine learning models 405 may be identified using a model ID. For example, the MLFN 430 may be associated with one or more model IDs corresponding to one or more machine learning models 405 (e.g., a machine learning model 405-a and a machine learning model 405-b). Each model ID may correspond to (e.g., and identify) a machine learning model 405 having a defined model structure 410, one or more parameter sets 415, or a combination thereof, as described herein. Additionally, or alternatively, a MLFN 430 may identify one or more machine learning models 405 using model structure IDs (e.g., MS IDs), parameter set IDs (E.g., PS IDs), or both. For example, the MLFN 430 may be associated with one or more model structure IDs, and each structure ID may identify a model structure 410 of a machine learning model 405. The MLFN 430 (e.g., or each structure ID) may also be associated with one or more parameter set IDs, each parameter set ID identifying a corresponding parameter set 415 for use with the corresponding model structure 410.

As such, model information may include MLFNs 430, model IDs, a model structure IDs, parameter set IDs, or a combination thereof. In some examples, each model ID may be associated with a model structure and one or more parameter sets, and may be represented by a string. For instance, the string may correspond to a flat namespace, such as a single value that represents a tuple that includes the model structure and the one or more parameter sets. Alternatively, the string may be a hierarchical namespace, such as the tuple including the model structure and the one or more parameter sets.

In some cases, each model ID may be unique with respect to a MLFN 430. For example, each model ID may identify a separate machine learning model 405 (e.g., for a vendor), and may be unique such that each model ID refers to a single corresponding machine learning model 405. Similarly, each model structure ID may also be unique with respect to a MLFN 430. In some cases, each model ID, model structure ID, or both, may be specific to a public land mobile network (PLMN). Additionally, or alternatively, the model IDs and model structure IDs may be standardized or may administered separately (e.g., per vendor) without standardizing.

A network entity 105 (e.g., a network) may configure and manage the use of machine learning models 405 for a UE 115. In some examples, the network entity 105 may manage machine learning at the UE 115 at a feature level, for example, by configuring the UE 115 by indicating a MLFN 430. Additionally, or alternatively, the network entity 105 may manage machine learning models 405 within each feature, and may configure the UE 115 using specific model IDs (e.g., indicating a model structure 410 and one or more parameter sets 415) corresponding to each feature. In some examples, the network entity 105 may manage the parameters of each machine learning model 405, and the network entity 105 may configure the UE 115 by indicating a model structure ID corresponding to a model structure 410 and one or more parameter sets 415. The parameter sets 415 may be explicitly indicated by the network entity 105 to the UE 115, which may allow for more flexibility of the parameters, and may reduce the storage requirements at the UE 115 for storing predetermined parameter sets 415. Alternatively, the network entity 105 may indicate the parameter sets 415 using one or more parameter IDs, which may reduce communication overhead between the UE 115 and the network entity 105.

In some examples, machine learning models 405 may be one-sided models, which may be performed entirely at a UE 115 or the network (e.g., at one or more network entities 105), or two-sided models, which may be performed at both the UE 115 and the network. One-sided models may be UE-side machine learning models 405, in which inference (e.g., running of the machine learning models 405) is performed at the UE 115. For example, the UE-side machine learning models 405 may involve non-UE specific inputs 420 (e.g., common to multiple UEs 115) and UE-specific inputs 420 (e.g., control inputs 420). In some cases, the UE 115 may receive control signaling or additional inputs 420 for the machine learning models 405 from a network entity 105, while the machine learning model 405 inference is performed entirely at the UE 115. Inference for network-side machine learning models 405 may be performed at the network (e.g., at one or more network entities 105), and the network may receive inputs 420 from the UE 115 to enter into the machine learning models 405. In some examples, the network may indicate the outputs 425 to the UE 115.

In two-sided machine learning models 405, joint inference may be performed. For example, one part of inference may be performed by the UE 115, and a remaining portion of the inference may be performed by one or more network entities 105. For example, the UE 115 may perform a first portion of the inference for a machine learning model 405, and the network may perform a second part of the inference (e.g., based on data received from the UE 115, for example). Alternatively, the network may perform the first portion of the inference for a machine learning model 405, and the UE 115 may perform the second part of the inference (e.g., based on data received from the network entity 105, for example). To perform inference for the two-sided machine learning model 405, a network entity 105 may signal one or more inputs 420 or other control signaling to the UE 115. Additionally, or alternatively, the UE 115 may transmit signaling indicating one or more inputs 420 or other control signaling to the network.

Accordingly, machine learning models 405 may be performed at a UE 115 or at one or more network entities 105, as managed by the network, to perform different functions that may improve the operations and efficiency of the UE 115 and the network as described herein.

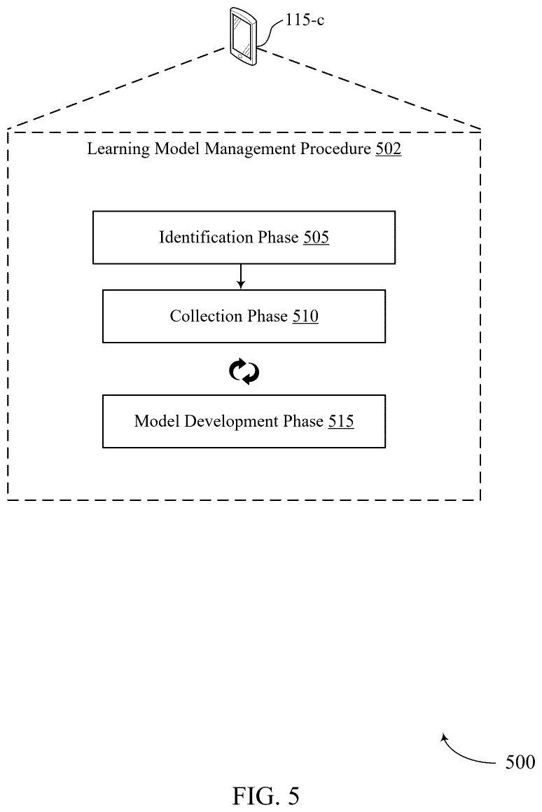

FIG. 5 shows an example of a block diagram 500 of a UE 115-c that supports predictive packet duplication for wireless communication in accordance with one or more aspects of the present disclosure. The UE 115-c may be an example of aspects of a UE 115 as described herein with reference to FIGS. 1 and 2, respectively. The UE 115-c may implement aspects of the wireless communications systems 100 or 200 as described with reference to FIGS. 1 and 2.

In the example of FIG. 5, the UE 115-c may support a learning model management procedure 502 associated with one or more machine learning models for predictive packet duplication, as described herein. The learning model management procedure 502 may include one or more of an identification phase 505, a collection phase 510 (also referred to as a data collection phase), and a model development phase 515.

One or more operations of the learning model management procedure 502 may be implemented by the UE 115-c or components (e.g., one or more memories storing processor-executable code, one or more processors coupled with the one or more memories and individually or collectively operable to execute the code to cause the UE 115-c to perform the operations) as described herein. In the following description of the learning model management procedure 502, the one or more operations performed by the UE 115-c may be performed in different orders or at different times. Some operations may also be omitted from the learning model management procedure 502, and other operations may be added to the learning model management procedure 502.

During the identification phase 505, the UE 115-c may identify an opportunity of applying a learning model. For example, the UE 115-c may identify a machine learning feature (MLF) for development at the UE 115-c. The UE 115-c may determine a use case for the learning model. In some examples, the UE 115-c may determine a task (e.g., an action) associated with the learning model, may determine inputs and outputs of the learning model, or both.

During the collection phase 510, the UE 115-c may collect data. For example, the UE 115-c may collect data based on actions or measurements that the UE 115-c performs, or the UE 115-c may collect data from multiple network elements (e.g., UEs, network entities). The data collected may be used as an input to the learning model for model development.

During the model development phase 515, the UE 115-c may prepare the data (e.g., before inputting the data to the learning model, as part of inputting the data to the learning model). To prepare the data, the UE 115-c may utilize one or more data filters, one or more selection criteria, or other data preparation parameters or procedures. The UE 115-c may design the model. A design of the learning model may be based on the MLF, the data available to the UE 115-c, one or more target outputs of the learning model, or a combination thereof. The UE 115-c may train the learning model (e.g., using the input data), and the UE 115-c may perform validation and testing of the learning model. For example, the UE 115-c may determine an accuracy or a reliability of the learning model and may calculate one or more accuracy metrics of the learning model. In some examples, the UE 115-c may continue to collect data for the learning model until the learning model has reached a threshold accuracy or reliability.

In some examples, multiple models may be developed for a same MLF (e.g., a same use case). The different models may be applicable to difference deployment environments, scenarios, or regions (e.g., geographical regions). In some examples, learning models may be universal models and may be generalized models that are applicable across deployments (e.g., all deployments). Universal models may be device specific or hardware specific. Some learning models may be regional models which may be deployment specific or network specific. Regional models may be applicable to some deployments, networks, and/or regions, but not others. Some learning models may be local models which may be applicable to a specific cell or to a local geographical area.

In some examples, the UE 115-c may be capable of out-of-band or on-demand download of learning models. For example, because some models may be regional models or local models, the UE 115-c may download such learning models once the UE 115-c is in the field (e.g., on-demand downloading). In some examples, on-demand downloading of learning models at the UE 115-c may enable the UE 115-c to perform firmware over-the-air (FOTA) updates of existing models (e.g., downloaded models, such as out-of-cand downloaded models), which may support federated learning of learning models.

Additionally, or alternatively, the model management procedure 502 may include a deployment of one or more learning models. For example, a UE 115-c may perform delivery or reception of a learning model (e.g., via an over the air interface or other signaling). That is, the UE 115-c may transmit an indication of the learning model to a network entity 105 or may receive an indication of the learning model from a network entity 105. In some examples, the indication of the learning model may indicate a partial model or a full model. A structure of the learning model may be known at a device receiving the learning model and the indication may include parameters for the model, or the indication may include a model (e.g., a model structure unknow by the receiving device) and parameters for the model.

In some examples, the indication of the learning model may include a model executable. The model executable may be optimized for different hardware platforms based on capabilities of the hardware platform and/or performance tradeoffs. The model executable may be downloaded directly to the UE 115-c or may be retrieved by the UE 115-c from a model repository. In some cases, due to a memory restriction at the UE 115-c, the learning model may be downloaded by the UE 115-c at runtime.

In some examples, the indication of the learning model may include one or more model management protocols. The model management protocols may include network and/or UE protocol functions to run the model. Additionally, or alternatively, the model management protocols may include layer 1 (L1)/layer 2 (L2) or RRC function handling (e.g., CSI type III support, MAC-control elements (MAC-CEs), RRC signaling for channel state feedback (CSF) configuration. In some cases, the model management protocols may include updated UE capabilities handling information (e.g., UE radio capability for CSF and supported CSF models).

In some examples, the UE 115-c may retrieve the learning model from one or more model repositories. The model repository may store the model to download (e.g., transfer) to the UE 115-c. In some examples, the model repository may be a server (e.g., mobile network operator (MNO)). A model and parameter set configuration (e.g., indicating a set of learning models to be downloaded to the UE 115-c) may be configurable (e.g., dynamic), or may be static. Downloading the learning model to the UE 115-c may be in accordance with a model download format. The model download format may be a binary executable file or image or may be a model descriptor or label (e.g., in accordance with an open neural network exchange (ONNX)). In some examples, model quantization and/or compilation may be during an out-of-cand period or may be during a runtime period of the UE 115-c.

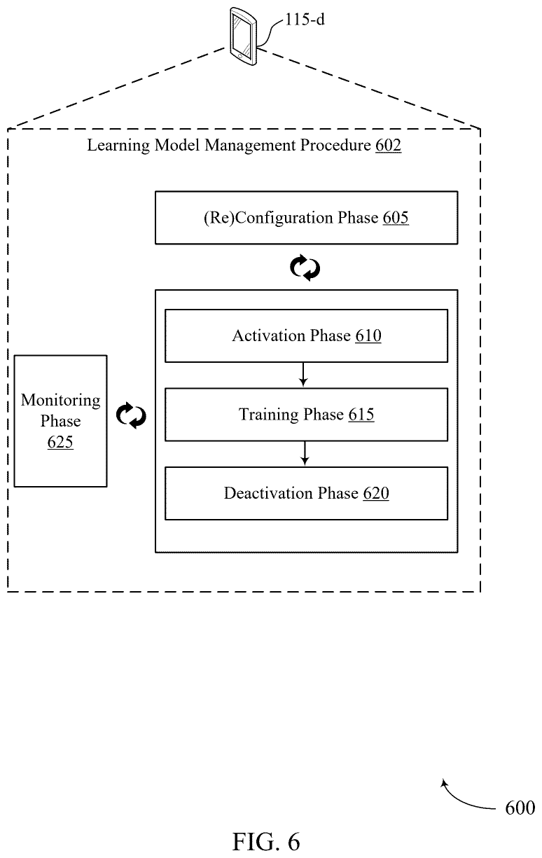

A learning model may undergo a life cycle, where the learning model progresses from one step of the life cycle to another. Steps of the model life cycle may include model development, model deployment, and model execution. For example, after development of a learning model, the learning model may be deployed. Based on model deployment, the UE 115-c may collect feedback of the learning model and may perform additional model development of the learning model (e.g., to improve or iterate on the learning model) based on the feedback. After model deployment, the learning model may be configured (e.g., for a particular use case, scenario), and the learning model may be executed by the UE 115-c (e.g., as described in greater detail with reference to FIG. 6). Based on model execution, the UE 115-c may collect feedback, may collect additional data, or both. The UE 115-c may perform model development of the learning model to improve the learning model based on the feedback and the additional data collected.

FIG. 6 shows an example of a block diagram 600 of a UE 115-d that supports predictive packet duplication for wireless communication in accordance with one or more aspects of the present disclosure. The UE 115-d may be an example of aspects of a UE 115 as described herein with reference to FIGS. 1 and 2, respectively. The UE 115-d may implement aspects of the wireless communications systems 100 or 200 as described with reference to FIGS. 1 and 2.

In the example of FIG. 6, the UE 115-d may support a learning model management procedure 602 associated with one or more machine learning models for predictive packet duplication, as described herein. The learning model management procedure 602 may include one or more of a (re) configuration phase 605, an activation phase 610, a training phase 615 (also referred to as an inference phase), a deactivation phase 620, or a monitoring phase 625. The one or more learning models may be locally stored (e.g., one or more memories storing processor-executable code) at the UE 115-d. Alternatively, the UE 115-d may obtain (e.g., download) the one or more learning models, for example, via a network entity 105 or a network entity 105, as described herein with reference to FIGS. 1 and 2.

One or more operations of the learning model management procedure 602 may be implemented by the UE 115-d or components (e.g., one or more memories storing processor-executable code, one or more processors coupled with the one or more memories and individually or collectively operable to execute the code to cause the UE 115-d to perform the operations) as described herein. In the following description of the learning model management procedure 602, the one or more operations performed by the UE 115-d may be performed in different orders or at different times. Some operations may also be omitted from the learning model management procedure 602, and other operations may be added to the learning model management procedure 602.

During the (re) configuration phase 605, the UE 115-d may receive, from a network entity 105, a set of one or more configurations including a set of one or more parameters for configuring or reconfiguring one or more learning models (e.g., artificial intelligence models, machine learning models). The UE 115-d may receive, from a network entity 105, a request message for configuring or reconfiguring the one or more learning models. The request may include the set of one or more configurations and one or more identifiers associated with one or more learning models. The UE 115-d may transmit, to the network entity 105, a response message that includes an acknowledgement of the request message.

In some examples, the set of one or more parameters may be for managing (e.g., training, updating, modifying) the one or more learning models. In some other examples, the set of one or more parameters may be an input for the one or more learning models, for example, for inference of the one or more learning models. In other examples, the set of one or more parameters may be for monitoring one or more performance metrics (also referred to as KPIs) for the one or more learning models. Additionally, or alternatively, the set of one or more configurations may include one or more RRC configurations (e.g., one or more measurement configurations, one or more MAC configurations, or the like).

During the activation phase 610, the UE 115-d may activate at least one learning model (e.g., for at least one action). During the training phase 615, the UE 115-d may train the at least one learning model to obtain a set of one or more outputs based at least in part on a set of one or more inputs (e.g., a set of one or more parameters). During the deactivation phase 620, the UE 115-d may deactivate the at least one learning model (e.g., for at least one action).

During the monitoring phase 625, the UE 115-d may monitor (e.g., track) a performance of the at least one learning model. One or more of a network entity 105 (e.g., a base station), or the UE 115-d may share (e.g., transmit, receive, exchange) feedback associated with the performance of the at least one learning model. The performance may be associated with a system performance (e.g., spectral efficiency, power consumption, delay, etc.) or a model performance (e.g., prediction accuracy, resource usage, inference delay, etc.). In some examples, one or more of a network entity 105, a base station, or the UE 115-d may trigger a switching event that includes switching (e.g., changing) from at least one learning model to at least one different learning model, for example, based at least in part on feedback associated with a performance of the at least one learning model. In some other examples, one or more of a network entity 105, a base station, or the UE 115-d may update the training of the at least one learning model based at least in part on the feedback associated with the performance of the at least one learning model.

The UE 115-d may switch from at least one learning model to at least one different learning model based at least in part on a function supported by the different learning model. In some examples, the UE 115-d may receive, from a network entity 105 (e.g., a base station), a request message to switch to the at least one different learning model. The request message may indicate an identifier associated with the at least one different learning model, and the UE 115-d may identify the least one different learning model based at least in part on the identifier. During the activation phase 610 of the learning model management procedure 602, the UE 115-d may activate the at least one different learning model (e.g., a different artificial intelligence/machine learning model). Additionally, during the deactivation phase 620, the UE 115-d may deactivate the at least one learning model (e.g., a current artificial intelligence/machine learning model).

Additionally, or alternatively, during the monitoring phase 625, the UE 115-d may trigger the switching event based at least in part on a change in one or more parameters of the UE 115-d (e.g., a number of antennas, a number of carriers, etc.). In some examples, the UE 115-d may trigger the switching event based at least in part on a change in a location of the UE 115-d (e.g., a change from an indoor environment to an outdoor environment, or vice-versa). In some other examples, the UE 115-d may trigger the switching event based at least in part on a change in a service (e.g., network slice, QoS flow, session, etc.).

Accordingly, the UE 115-d may be configured to support managing (e.g., configuring, reconfiguring, activating, deactivating, monitoring, reporting, etc.) of one or more leaning models.

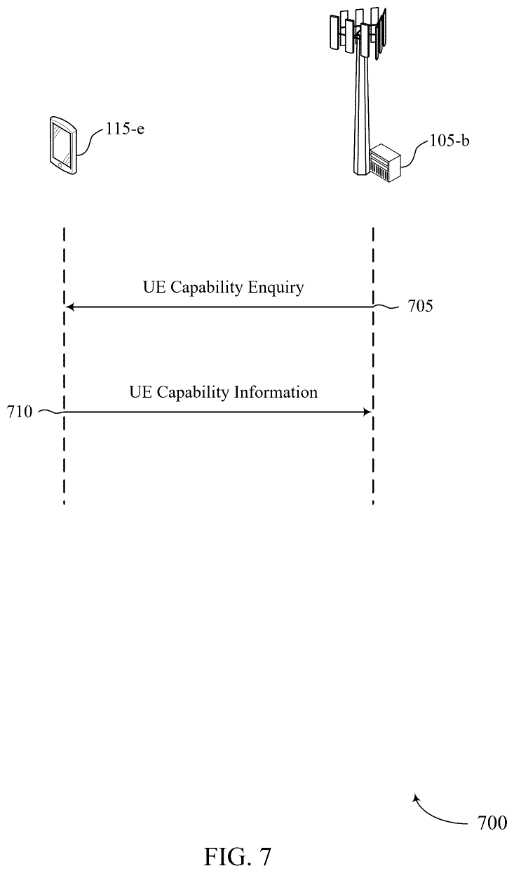

FIG. 7 shows an example of a process flow 700 that supports predictive packet duplication for wireless communication in accordance with one or more aspects of the present disclosure. The process flow 700 may implement aspects of the wireless communications system 100 or 200 as described with reference to FIGS. 1 and 2. Additionally, or alternatively, the process flow 700 may implement or be implemented by aspects of the ML architecture 400 as described herein with reference to FIG. 4. The process flow 700 may include a UE 115-e and a network entity 105-b, which may be examples of UEs 115 and network entities 105 as described herein. In the following description of the process flow 700, the operations between the UE 115-e and the network entity 105-b may be transmitted in a different order than the example order shown, or the operations performed by the UE 115-e and the network entity 105-b may be performed in different orders or at different times. Some operations may also be omitted from the process flow 700, and other operations may be added to the process flow 700.

In the example of FIG. 7, the UE 115-e may support providing an indication to the network entity 105-b of one or more learning models, including one or more features for predictive packet duplication, supported by the UE 115-e. At 705, the network entity 105-b may transmit, and the UE 115-e may receive, a request message (e.g., a UE capability enquiry). The UE 115-e may determine, in response to the UE capability enquiry, a set of one or more UE capabilities. For example, the UE 115-e may determine whether the UE 115-e supports artificial intelligence/machine learning functionality, including one or more learning models (e.g., artificial intelligence/machine learning models) or one or more features associated with the one or more learning models.

At 710, the UE 115-e may transmit, and the network entity 105-b may receive, a response messages (e.g., UE capability information), in response to the request message. The UE capability information may include a set of one or more features supported by the UE 115-e. In some examples, the UE capability information may include a set of one or more identifiers associated with the one or more learning models, supported by the UE 115-e. Additionally, or alternatively, the UE capability information may include at least one field (e.g., information element (IE), flag, or the like) that indicates whether a corresponding learning model is loaded (e.g., initialized, stored, cached, or the like) at the UE 115-e. Additionally, or alternatively, the UE capability information may include a set of one or more identifiers associated with one or more learning model structures, or a set of one or more parameters for one or more features associated with the one or more learning model structures.

Accordingly, the UE 115-e may be configured to support exchange of UE capability information associated with one or more learning models.

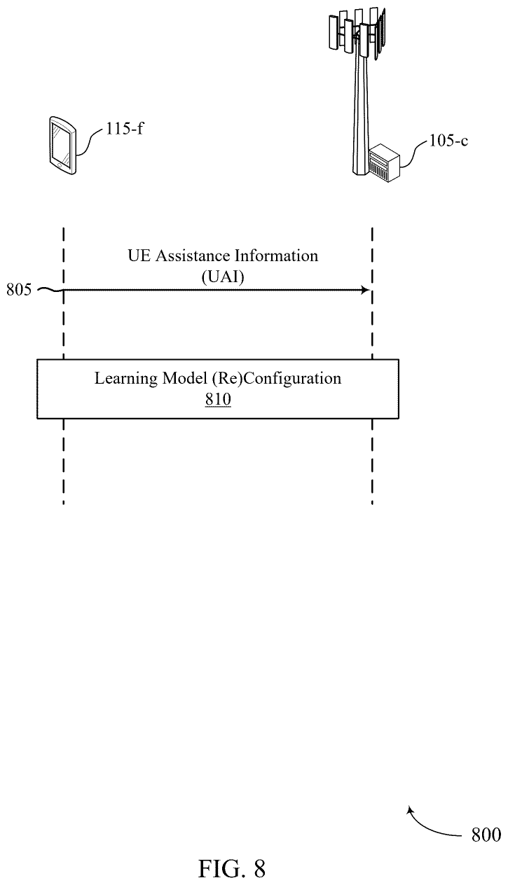

FIG. 8 shows an example of a process flow 800 that supports predictive packet duplication for wireless communication in accordance with one or more aspects of the present disclosure. The process flow 800 may implement aspects of the wireless communications system 100 or 200 as described with reference to FIGS. 1 and 2. Additionally, or alternatively, the process flow 800 may implement or be implemented by aspects of the ML architecture 400 as described herein with reference to FIG. 4. The process flow 800 may include a UE 115-f and a network entity 105-c, which may be examples of UEs 115 and network entities 105 as described herein. In the following description of the process flow 800, the operations between the UE 115-f and the network entity 105-c may be transmitted in a different order than the example order shown, or the operations performed by the UE 115-f and the network entity 105-c may be performed in different orders or at different times. Some operations may also be omitted from the process flow 800, and other operations may be added to the process flow 800.

In the example of FIG. 8, the UE 115-f may support providing UE assistance information (UAI) to the network entity 105-c. More specifically, the UE 115-f may support transmitting, to the network entity 105-c, UAI for managing one or more learning models. At 805, the UE 115-f may transmit, and the network entity 105-c may receive, UAI that may indicate one or more restrictions (also referred to as restricted UE capabilities) associated with the one or more learning models. For example, the restricted UE capabilities may include a set of one or more learning models, a set of one or more identifier associated with the set of one or more learning models, or both. In some examples, the restricted UE capabilities may exclude the set of one or more identifiers. In some examples, the UE 115-f may indicate a request to adjust (e.g., reduce, decrease, increase) a concurrency of the one or more learning models. For example, the UE 115-f may indicate a threshold number of concurrency (e.g., “maxartificial intelligencemachine learningconcurrency-Preference”) associated with the one or more learning models.

The UE 115-f may generate and transmit the UAI to the network entity 105-c based at least in part on a condition (e.g., an event). One or more examples of a condition may include, but is not limited to, a battery level of the UE 115-f satisfying a battery level threshold, a processor usage level of one or more processors of the UE 115-f satisfying a processor usage level threshold, or a heat level of one or more processors of the UE 115-f satisfying a heat level threshold. For example, the UE 115-f may transmit the UAI to the network entity 105-c to manage (e.g., deactivate, activate) one or more learning models at the UE 115-f based at least in part on one or more of the battery level of the UE 115-f satisfying the battery level threshold, the processor usage level of the one or more processors of the UE 115-f satisfying the processor usage level threshold, or the heat level of the one or more processors of the UE 115-f satisfying the heat level threshold.

Additionally, or alternatively, in some examples, the UAI may include a request for a set of one or more configurations associated with one or more learning models. In some examples, the UE 115-f may request the network entity 105-c for the set of one or more configurations associated with the one or more learning models based at least in part on a change in an environment of the UE 115-f. In some other examples, the UE 115-f may request the network entity 105-c for the set of one or more configurations associated with the one or more learning models based at least in part on a change in a state of the UE 115-f (e.g., a change between one or more of an idle state, an inactive state, or a connected state).

In other examples, the UE 115-f may request the network entity 105-c for the set of one or more configurations associated with the one or more learning models based at least in part on a session establishment associated with a network slice. For example, the UE 115-f may establish a session (e.g., a PDU session) associated with the network slice, and request the network entity 105-c for the set of one or more configurations associated with the one or more learning models. In some other examples, the UE 115-f may request the network entity 105-c for the set of one or more configurations associated with the one or more learning models based at least in part on a change in a geographic coverage area of the UE 115-f. For example, the UE 115-f may enter a new geographic coverage area of a cell, public land mobile network (PLMN), and request the network entity 105-c for the set of one or more configurations associated with the one or more learning models.

At least one configuration of the set of one or more configurations associated with provisioning of network data as input for one or more learning models (e.g., artificial intelligence/machine learning models). In some examples, the at least one configuration may indicate at least one identifier associated with at least one learning model supporting the network data as input to the least one learning model. In some examples, the UE 115-f may request (e.g., on-demand) for the network data from the network entity 105-c via the UAI, for example, based at least in part on the set of one or more configurations associated with provisioning of network data as input for one or more learning models (e.g., artificial intelligence/machine learning models).

At 810, one or more of the UE 115-f or the network entity 105-c may configure or reconfigure at least one learning model. For example, the network entity 105-c may select at least one learning model to deactivate at the UE 115-f, based at least in part on the UAI, and transmit control signaling (e.g., RRC, MAC-CE, DCI) for deactivating the at least one learning model. For example, the network entity 105-c may determine and select which learning model to deactivate at the UE 115-f based at least in part on the UAI, and transmit the control signaling (e.g., RRC, MAC-CE, DCI) that indicates for the UE 115-f to deactivate the at least one learning model. Additionally, or alternatively, the network entity 105-c may determine and select which learning model to configure or reconfigure and activate at the UE 115-f based at least in part on the UAI. For example, the network entity 105-c may determine and select which learning model to activate at the UE 115-f based at least in part on the UAI, and transmit control signaling (e.g., RRC, MAC-CE, DCI) that indicates for the UE 115-f to activate the at least one learning model.

Accordingly, the UE 115-f may be configured to support exchange of UAI for managing machine learning models that support predictive packet duplication for the UE 115-f.

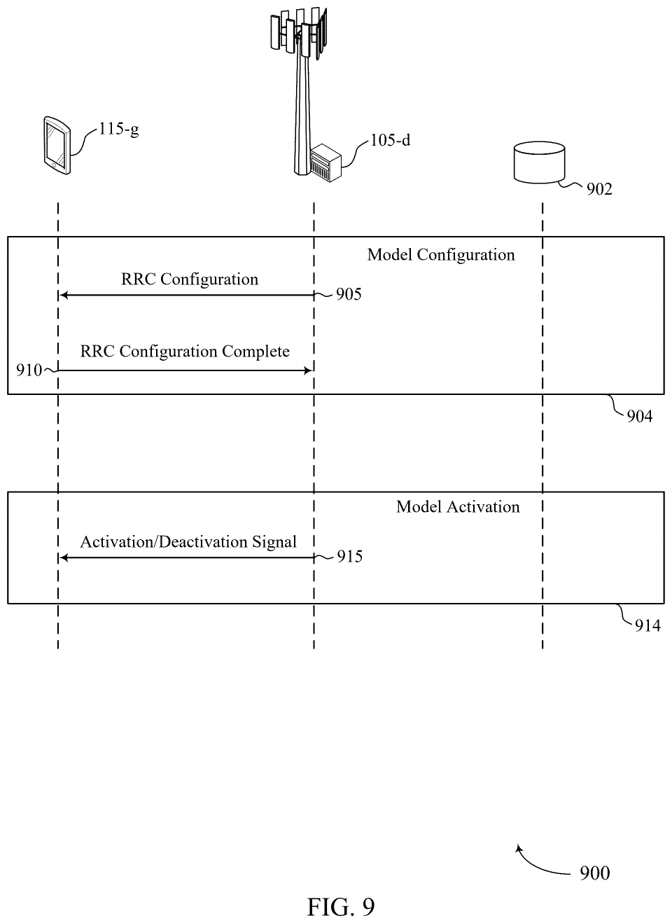

FIG. 9 shows an example of a process flow 900 that supports predictive packet duplication for wireless communication in accordance with one or more aspects of the present disclosure. The process flow 900 may implement aspects of the wireless communications system 100 or 200 as described with reference to FIGS. 1 and 2. Additionally, or alternatively, the process flow 900 may implement or be implemented by aspects of the ML architecture 400 as described herein with reference to FIG. 4. The process flow 900 may include a UE 115-g and a network entity 105-d, which may be examples of UEs 115 and network entities 105 as described herein. Additionally, the process flow 900 may include a repository 902 (e.g., a database) storing one or more learning models. In the following description of the process flow 900, the operations between the UE 115-g, the network entity 105-d, and the repository 902 may be transmitted in a different order than the example order shown, or the operations performed by the UE 115-g, the network entity 105-d, and the repository 902 may be performed in different orders or at different times. Some operations may also be omitted from the process flow 900, and other operations may be added to the process flow 900.

In the example of FIG. 9, one or more of the UE 115-g or the network entity 105-d may support performing a procedure, such as a model configuration procedure 904. The model configuration procedure 904 may include an exchange of a set of one or more configurations (or a set of one or more parameters) associated with one or more learning models. The set of one or more configurations (or the set of one or more parameters) associated with the one or more learning models may be stored at the repository 902 (e.g., a database, or the like), which the network entity 105-d may obtain from the repository 902.

At 905, the network entity 105-d may transmit, and the UE 115-g may receive, an RRC configuration message, which may include one or more sets of one or more configurations (or one or more sets of one or more parameters) associated with one or more learning models. The network entity 105-d may transmit, and the UE 115-g may receive, the RRC configuration message during an RRC configuration procedure. In some examples, the UE 115-g may configure one or more learning models via a layer 3 (L3) of the UE 115-g and based at least in part on the one or more sets of one or more configurations (or the one or more sets of one or more parameters) received in the RRC configuration message. At 910, the UE 115-g may transmit, and the network entity 105-d may receive, an RRC configuration complete message, for example, based at least in part on the RRC configuration message. The RRC configuration complete message may indicate a completion of the RRC configuration procedure, including configuring of the one or more learning models.

In the example of FIG. 9, additionally, or alternatively, at least one configuration of the sets of one or more configurations may be for provisioning network data by the network entity 105-d to the UE 115-g for input to one or more learning models (e.g., artificial intelligence/machine learning models). In some examples, the at least one configuration may indicate at least one identifier associated with at least one learning model supporting the network data as input to the least one learning model. In some examples, the UE 115-g may request, the network entity 105-d, to activate or deactivate provisioning of network data as input to the at least one learning model via a MAC-CE. In some examples, the UE 115-g may receive, and the network entity 105-d may transmit, the network data via a unicast transmission and over a physical downlink channel (e.g., a physical downlink control channel (PDCCH), a physical downlink shared channel (PDSCH)). In some other examples, the UE 115-g may receive, and the network entity 105-d may transmit, the network data via a MAC-CE or an RRC message. In other examples, the UE 115-g may receive, and the network entity 105-d may transmit (e.g., broadcast), the network data via system information or a multicast broadcast service (MBS) transmission.

Additionally, or alternatively, at least one configuration of the sets of one or more configurations may be for provisioning, to the network entity 105-d, UE data as input for one or more learning models (e.g., artificial intelligence/machine learning models). In some examples, the at least one configuration may indicate at least one identifier associated with at least one learning model supporting the UE data as input to the least one learning model. The network entity 105-d may request, from the UE 115-g, to activate or deactivate provisioning of UE data as input to the at least one learning model via a MAC-CE. In some examples, the UE 115-g may transmit, and the network entity 105-d may receive, UE data via a unicast transmission and over a physical uplink channel (e.g., a physical uplink control channel (PUCCH), a physical uplink shared channel (PUSCH)). In some other examples, the UE 115-g may transmit, and the network entity 105-d may receive, the UE data via a MAC-CE or an RRC message.

At 915, the network entity 105-d may transmit, and the UE 115-g may receive, a signal (also referred to as an activation signal or a deactivation signal) for activating or deactivating one or more learning models. In some examples, the network entity 105-d may transmit, and the UE 115-g may receive via a layer 2 (L2) of the UE 115-g, the signal for activating or deactivating the one or more learning models, as part of a model activation procedure 914. For example, the network entity 105-d may transmit, and the UE 115-g may receive, a MAC-CE that activates or deactivates the one or more learning models. In some examples, activating or deactivating the one or more learning models may be based at least in part on a switching event as described herein with reference to FIGS. 4 through 6.

Accordingly, one or more of the UE 115-g or the network entity 105-d may be configured to support managing machine learning models based at least in part on activating or deactivating one or more learning models via MAC-CE, which allows predictive packet duplication using machine learning models.

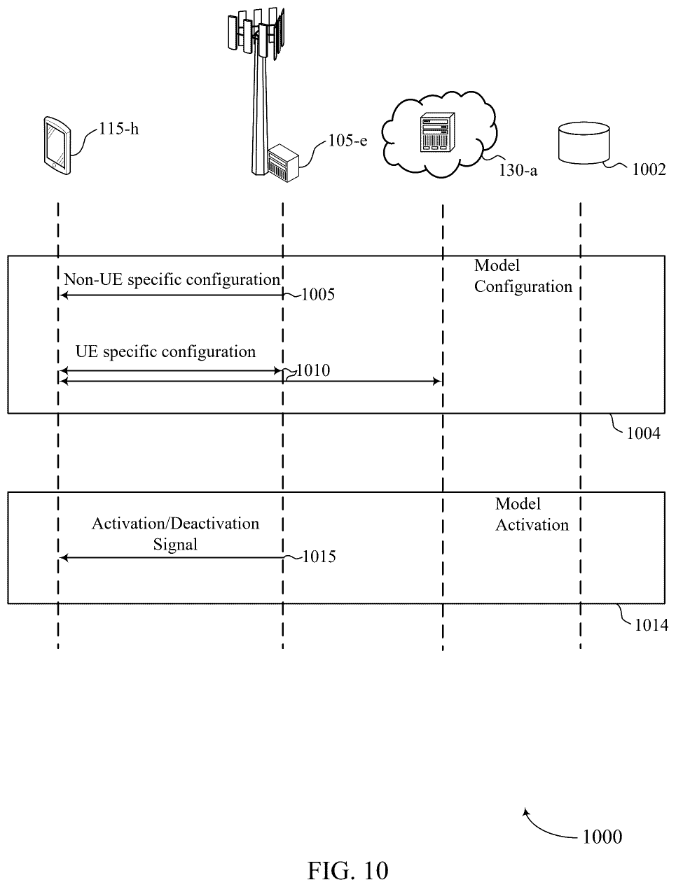

FIG. 10 shows an example of a process flow 1000 that supports predictive packet duplication for wireless communication in accordance with one or more aspects of the present disclosure. The process flow 1000 may implement aspects of the wireless communications system 100 or 200 as described with reference to FIGS. 1 and 2. Additionally, or alternatively, the process flow 1000 may implement or be implemented by aspects of the ML architecture 400 as described herein with reference to FIG. 4. The process flow 1000 may include a UE 115-h, a network entity 105-e, and a core network 130-a, which may be examples of UEs 115, network entities 105, and core networks 130 as described herein. Additionally, the process flow 1000 may include a repository 1002 (e.g., a database) storing one or more learning models. In the following description of the process flow 1000, the operations between the UE 115-h, the network entity 105-e, the core network 130-a, and the repository 1002 may be transmitted in a different order than the example order shown, or the operations performed by the UE 115-h, the network entity 105-e, the core network 130-a, and the repository 1002 may be performed in different orders or at different times. Some operations may also be omitted from the process flow 1000, and other operations may be added to the process flow 1000.

In the example of FIG. 10, one or more of the UE 115-h, the network entity 105-c, or the core network 130-a may support performing one or more procedures, such as a model configuration procedure 1004. The model configuration procedure 1004 may exchange of a set of one or more configurations (or a set of one or more parameters) associated with one or more learning models. For example, one or more of the UE 115-h, the network entity 105-e, or the core network 130-a may support performing one or more procedures, which may exchange of the set of one or more configurations (or the set of one or more parameters) associated with the one or more learning models based at least in part on a state (e.g., an idle state, an inactivate state) of the UE 115-h. In some examples, one or more of the UE 115-h, the network entity 105-e, or the core network 130-a may support activating or deactivating the one or more learning models for inference during the state of the UE 115-h. For example, one or more of the UE 115-h, the network entity 105-e, or the core network 130-a may support activating or deactivating the one or more learning models to perform an inference (e.g., training) of the one or more learning models and cell selection, cell reselection, RLF recovery, measurement operations, random access channel operations (e.g., beam selection, random access channel occasions (RO), and the like).

At 1005, the network entity 105-e may transmit, and the UE 115-h may receive, a set of one or more non-UE specific configurations. For example, the network entity 105-e may broadcast, and the UE 115-h may receive, system information including the set of one or more non-UE specific configurations. The system information may include a system information block (SIB). The set of one or more non-UE specific configurations may include one or more sets of one or more parameters, which may be associated with a set of one or more learning models and include a set of one or more identifiers associated with the set of one or more learning models, etc.

Additionally, or alternatively, at 1010, the network entity 105-e may transmit, and the UE 115-h may receive, for example, via a unicast transmission, a set of one or more UE specific configurations for predictive packet duplication, as described herein. For example, the network entity 105-e may transmit, and the UE 115-h may receive, an RRC message including the set of one or more UE specific configurations. The set of one or more UE specific configurations may include one or more sets of one or more parameters, which may be associated with a set of one or more learning models including a set of one or more identifiers associated with the set of one or more learning models. In some examples, the RRC message may be an RRC release message during an RRC release procedure. In some examples, one or more of the UE 115-h, the network entity 105-e, or the core network 130-a (e.g., one or more network functions associated with the core network 130-a) may exchange one or more NAS messages associated with the set of one or more UE specific configurations.

At 1015, the network entity 105-e may transmit, and the UE 115-h may receive, a signal (also referred to as an activation signal or a deactivation signal) for activating or deactivating one or more learning models, as part of a model activation procedure 1014. In some examples, the network entity 105-e may transmit, and the UE 115-h may receive, the signal for activating or deactivating the one or more learning models. For example, the network entity 105-e may transmit, and the UE 115-h may receive, a MAC-CE that activates or deactivates the one or more learning models and may perform an inference (e.g., training) of the one or more learning models during an idle state or an inactivate state of the UE 115-h. As such, activating or deactivating the one or more learning models may be based at least in part on the idle state or the inactivate state of the UE 115-h.

Accordingly, one or more of the UE 115-h, the network entity 105-e, or the core network 130-a may support activating or deactivating one or more learning models and for inference of the one or more learning models during an idle state or an inactivate state of the UE 115-h.

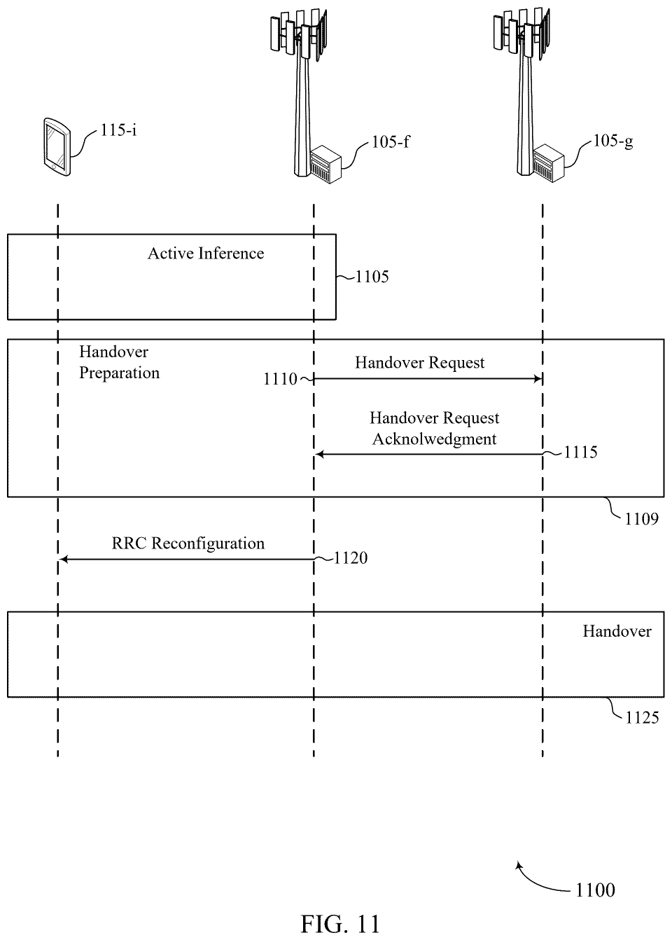

FIG. 11 shows an example of a process flow 1100 that supports predictive packet duplication for wireless communication in accordance with one or more aspects of the present disclosure. The process flow 1100 may implement aspects of the wireless communications system 100 or 200 as described with reference to FIGS. 1 and 2. Additionally, or alternatively, the process flow 1100 may implement or be implemented by aspects of the ML architecture 400 as described herein with reference to FIG. 4. The process flow 1100 may include a UE 115-i, a network entity 105-f, and a network entity 105-g, which may be examples of UEs 115 and network entities 105 as described herein. In the following description of the process flow 1100, the operations between the UE 115-i, the network entity 105-f, and the network entity 105-g may be transmitted in a different order than the example order shown, or the operations performed by the UE 115-i, the network entity 105-f, and the network entity 105-g may be performed in different orders or at different times. Some operations may also be omitted from the process flow 1100, and other operations may be added to the process flow 1100.

In the example of FIG. 11, one or more of the UE 115-i, the network entity 105-f, and the network entity 105-g may support managing machine learning models for predictive packet duplication of the UE 115-i. More specifically, one or more of the UE 115-i, the network entity 105-f, and the network entity 105-g may support managing artificial intelligence/machine learning functionality associated with the UE 115-i during a handover procedure, which may include switching (e.g., transferring) a connection of the UE 115-i from the network entity 105-f (also referred to as a source base station) to the network entity 105-g (also referred to as a target base station) and while maintaining ongoing artificial intelligence/machine learning functionality.

At 1105, one or more of the UE 115-i or the network entity 105-f may perform an active inference (e.g., training) of one or more learning models. The inference (e.g., training) of the one or more learning models may be based at least in part on one or more sets of one or more configurations, including one or more sets of one or more parameters, configured by the network entity 105-f.

At 1110, as part of a handover preparation procedure 1109, the network entity 105-f may transmit, and the network entity 105-g may receive, a handover request message, which may include context information (e.g., artificial intelligence/machine learning context) associated with the one or more learning models. At 1115, the network entity 105-g may transmit, and the network entity 105-f may receive, a handover request acknowledgment message, which may include one or more sets of one or more configurations, including one or more sets of one or more parameters, configured by the network entity 105-g. Put another way, the network entity 105-g may provide a set of one or more artificial intelligence/machine learning configurations for the UE 115-i to apply after being handed over to the network entity 105-g by the network entity 105-f. In some examples, the network entity 105-f may determine the sets of one or more configurations, including the one or more sets of one or more parameters, based at least in part on the context information (e.g., artificial intelligence/machine learning context) received from the network entity 105-g. Additionally, or alternatively, the network entity 105-f may determine the sets of one or more configurations, including the one or more sets of one or more parameters, based at least in part on one or more of UE capabilities of the UE 115-i or network capabilities of the network entity 105-g. In some examples, one or more of the UE 115-i or the network entity 105-g may support partial or full artificial intelligence/machine learning functionality (e.g., enabling of one or more features associated with at least one learning model).

At 1120, the network entity 105-f may transmit, and the UE 115-i may receive, an RRC reconfiguration message, which include the sets of one or more configurations, including the one or more sets of one or more parameters, configured by the network entity 105-g. At 1125, one or more of the UE 115-i, the network entity 105-f, or the network entity 105-g may complete the handover procedure.

Accordingly, one or more of the UE 115-i, the network entity 105-f, or the network entity 105-g may support predictive packet duplication for the UE 115-i using one or more machine learning models.

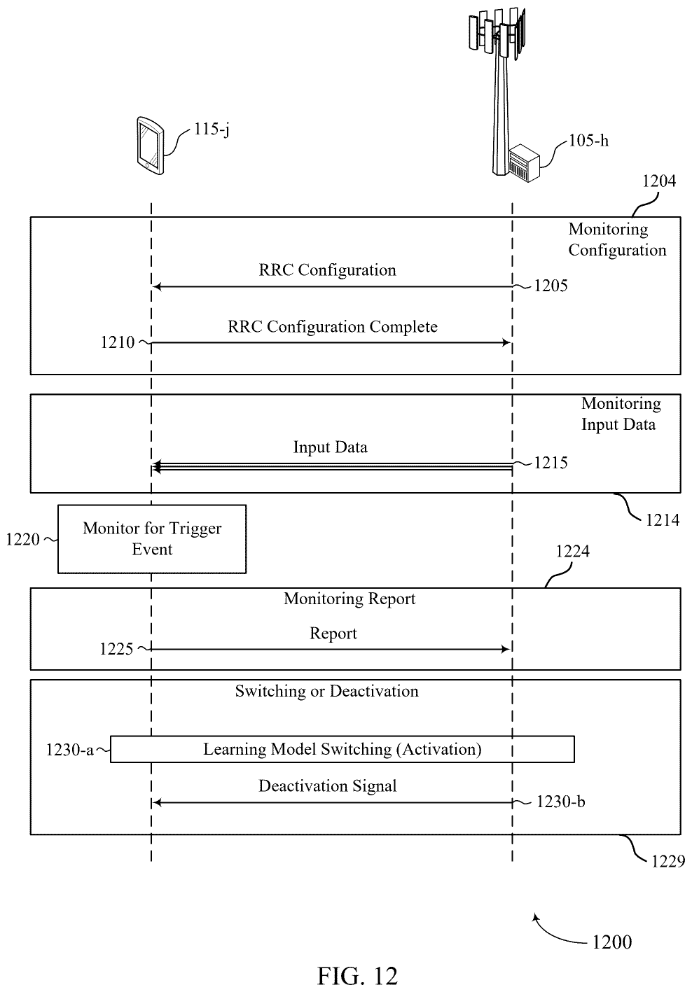

FIG. 12 shows an example of a process flow 1200 that supports predictive packet duplication for wireless communication in accordance with one or more aspects of the present disclosure. The process flow 1200 may implement aspects of the wireless communications system 100 or 200 as described with reference to FIG. 1 or 2. Additionally, or alternatively, the process flow 1200 may implement or be implemented by aspects of the ML architecture 400 as described herein with reference to FIG. 4. The process flow 1200 may include a UE 115-j and a network entity 105-h, which may be examples of UEs 115 and network entities 105 as described herein. In the following description of the process flow 1200, the operations between the UE 115-j and the network entity 105-h may be transmitted in a different order than the example order shown, or the operations performed by the UE 115-j and the network entity 105-h may be performed in different orders or at different times. Some operations may also be omitted from the process flow 1200, and other operations may be added to the process flow 1200.

In the example of FIG. 12, one or more of the UE 115-j or the network entity 105-h may support activating and deactivating one or more learning models based at least in part on reporting of feedback associated with the one or more learning models by the UE 115-j.

At 1205, as part of a monitoring configuration procedure 1204, the network entity 105-h may transmit, and the UE 115-j may receive, an RRC message that includes a set of one or more RRC configurations, which may include a set of one or more parameters. In some examples, one or more parameters of the set of one or more parameters may include one or more performance KPIs or one or more system KPIs, or a combination thereof. In some other examples, one or more parameters of the set of one or more parameters may include one or more monitoring events (e.g., thresholds, conditions). In other examples, one or more parameters of the set of one or more parameters may include one or more reporting events, reporting periodicity, etc. At 1210, the UE 115-j may transmit, and the network entity 105-h may receive, an RRC configuration complete message.

At 1215, as part of a monitoring input data procedure 1214, the network entity 105-h may transmit, and the UE 115-j may receive, input data, which may be input for one or more learning models at the UE 115-j. In some examples, the network entity 105-h may transmit, and the UE 115-j may receive, input data via one or more unicast transmissions. In some other examples, the network entity 105-h may broadcast, and the UE 115-j may receive, input data via one or more broadcast transmissions as described herein with reference to FIGS. 4 through 9.

At 1220, the UE 115-j may monitor for one or more events (e.g., threshold satisfied, conditions satisfied) associated with the one or more learning models. At 1225, as part of a monitoring report procedure 1224, the UE 115-j may transmit, and the network entity 105-h may receive, a report based at least in part on the one or more events. The report may indicate the one or more performance KPIs or the one or more system KPIs, or a combination thereof.

At 1230-a, as part of a switching or deactivation procedure 1229, one or more of the UE 115-j or the network entity 105-h may switch between one or more learning models as described herein. For example, one or more of the UE 115-j or the network entity 105-h may active at least one learning model of the one or more learning models based at least in part on the reported one or more performance KPIs or the reported one or more system KPIs, or a combination thereof. Additionally, or alternatively, at 1230-b, one or more of the UE 115-j or the network entity 105-h may activate or deactivate at least one learning model of the one or more learning models based at least in part on the reported one or more performance KPIs or the reported one or more system KPIs, or a combination thereof.

Accordingly, one or more of the UE 115-j or the network entity 105-h may support activating and deactivating one or more learning models based at least in part on reported feedback associated with the one or more learning models by the UE 115-j.

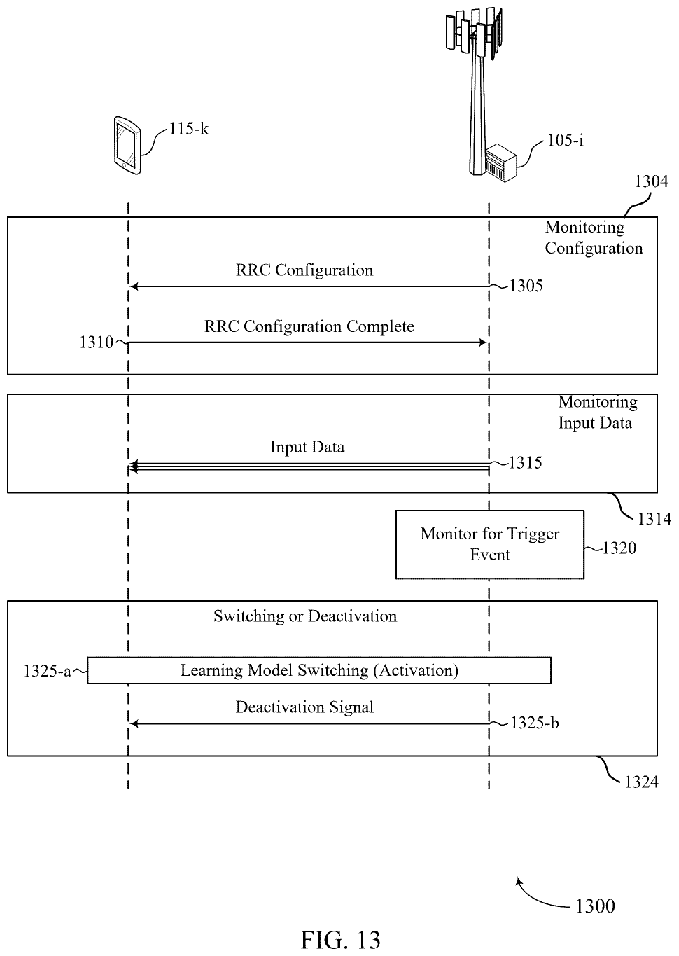

FIG. 13 shows an example of a process flow 1300 that supports predictive packet duplication for wireless communication in accordance with one or more aspects of the present disclosure. The process flow 1300 may implement aspects of the wireless communications system 100 or 200 as described with reference to FIGS. 1 and 2. Additionally, or alternatively, the process flow 1300 may implement or be implemented by aspects of the ML architecture 400 as described herein with reference to FIG. 4. The process flow 1300 may include a UE 115-k and a network entity 105-i, which may be examples of UEs 115 and network entities 105 as described herein. In the following description of the process flow 1300, the operations between the UE 115-k and the network entity 105-i may be transmitted in a different order than the example order shown, or the operations performed by the UE 115-k and the network entity 105-i may be performed in different orders or at different times. Some operations may also be omitted from the process flow 1300, and other operations may be added to the process flow 1300.

In the example of FIG. 13, one or more of the UE 115-k or the network entity 105-i may support activating and deactivating one or more learning models based at least in part on monitoring by the network entity 105-i of the one or more learning models.

At 1305, as part of a monitoring configuration procedure 1304, the network entity 105-i may transmit, and the UE 115-k may receive, an RRC message that includes set of one or more RRC configurations, which may include a set of one or more parameters. In some examples, one or more parameters of the set of one or more parameters may include one or more performance KPIs or one or more system KPIs, or a combination thereof. At 1310, the UE 115-k may transmit, and the network entity 105-i may receive, an RRC configuration complete message.

At 1315, as part of a monitoring input data procedure 1314, the network entity 105-i may receive, and the UE 115-k may transmit, input data, which may be input for one or more learning models at the network entity 105-i. In some examples, the network entity 105-i may receive, and the UE 115-k may transmit, input data via one or more unicast transmissions. At 1320, the network entity 105-i may monitor for one or more events (e.g., threshold satisfied, conditions satisfied) associated with the one or more learning models at the network entity 105-i.

At 1325-a, as part of a switching or deactivation procedure 1324, one or more of the UE 115-k or the network entity 105-i may switch between one or more learning models based at least in part on the one or more events as described herein. For example, one or more of the UE 115-k or the network entity 105-i may active at least one learning model of the one or more learning models based at least in part on the one or more events as described herein. Additionally, or alternatively, at 1325-b, one or more of the UE 115-k or the network entity 105-i may deactivate at least one learning model of the one or more learning models based at least in part on the one or more events as described herein. Accordingly, one or more of the UE 115-k or the network entity 105-i may support activating and deactivating one or more learning models for predictive packet duplication for the UE 115-k based at least in part on monitoring by the network entity 105-i of the one or more learning models.

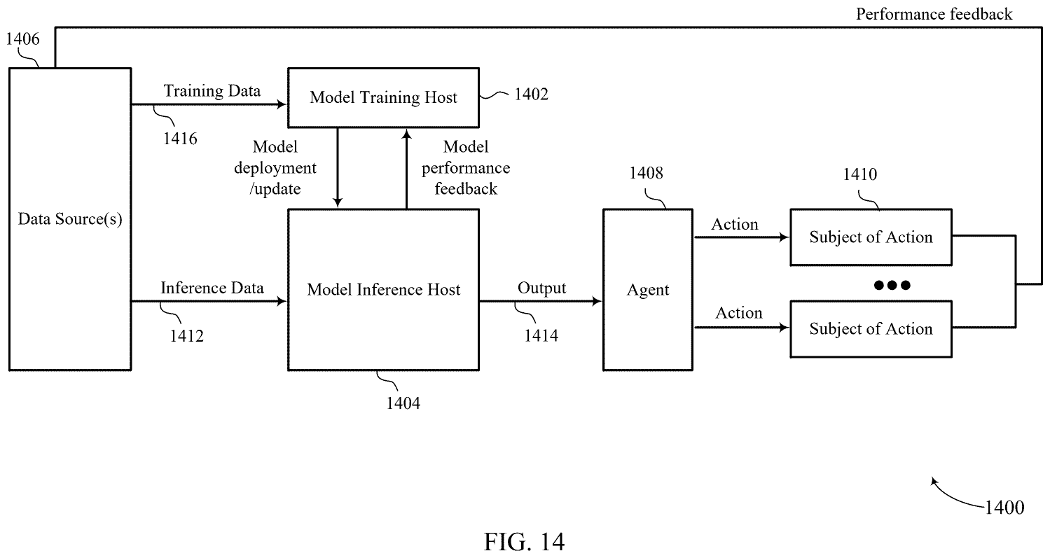

FIG. 14 is an illustrative block diagram of an example ML architecture 1400 that may be used for wireless communications in accordance with one or more aspects of the present disclosure. The ML architecture 1400 may be used for wireless communications in any of the various implementations, processes, environments, networks, or use cases listed above. As illustrated, architecture 1400 includes multiple logical entities, such as model training host 1402, model inference host 1404, data source(s) 1406, and agent 1408. Model inference host 1404 is configured to run an ML model based on inference data 1412 provided by data source(s) 1406. Model inference host 1404 may produce output 1414, which may include a prediction or inference, such as a discrete or continuous value based on inference data 1412, which may then be provided as input to the agent 1408.

Agent 1408 may represent an element or an entity of a wireless communication system including, for example, a radio access network (RAN), a wireless local area network, a device-to-device (D2D) communications system, etc. As an example, agent 1408 may be a UE (e.g., UE 115 as described with reference to FIGS. 1 through 13 and 15 through 18), a base station (e.g., a base station 140 as described with reference to FIG. 1), or a disaggregated network entity (such as a CU, a DU, or a RU as described with reference to FIG. 1), an access point, a wireless station, a RIC in a cloud-based RAN, among some examples. Additionally, agent 1408 also may be a type of agent that depends on the type of tasks performed by model inference host 1404, the type of inference data 1412 provided to model inference host 1404, or the type of output 1414 produced by model inference host 1404.

Agent 1408 may perform one or more actions associated with receiving output 1414 from model inference host 1404. For example, if agent 1408 is a UE 115 and the output from model inference host 1404 is associated with predictive packet duplication, the agent 1408 may determine duplication of packets on a per PDU basis based on output 1414.

Agent 1408 may indicate the one or more actions performed to at least one subject of action 1410. For example, if the agent 1408 determines to duplicate one or more packets, the agent 1408 may output an indication to the subject of action 1410 (such as, one or more protocol layers of the UE 115).

As another example, agent 1408 may be a UE 115 and output 1414 from model inference host 1404 may be an indication of whether to duplicate one or more packets. For example, model inference host 1404 may determine, using one or more KPIs associated with a DRB, whether one or more packets are to be duplications. Based on the duplication determination, agent 1408 may select one or more radio link control legs associated with the PDCP layer of the protocol stack for transmission of the one or more packets and output an indication to the subject of action 1410 (such as, one or more protocol layers of the UE 115). In some cases, agent 1408 and the subject of action 1410 are the same entity.

Data can be collected from data sources 1406, and may be used as training data 1416 for training an ML model, or as inference data 1412 for feeding an ML model inference operation. Data sources 1406 may collect data from various subject of action 1410 entities (such as, the UE 115 or the network entity 105), and provide the collected data to a model training host 1402 for ML model training. For example, after a subject of action 1410 (such as, a UE 115) obtains one or more packet acknowledgments, channel measurements, and associated KPIs from agent 1408, the subject of action 1410 may provide performance feedback associated with the packet duplication (e.g., a duplication statistics report) to the data sources 1406. The performance feedback may be used by the model training host 1402 for monitoring or evaluating the ML model performance. In some examples, if output 1414 provided to agent 1408 is inaccurate (or the accuracy is below an accuracy threshold), model training host 1402 may provide feedback to model inference host 1404 to modify or retrain the ML model used by model inference host 1404, such as via an ML model deployment update.

Model training host 1402 may be deployed at the same or a different entity than that in which model inference host 1404 is deployed. For example, in order to offload model training processing, which can impact the performance of model inference host 1404, model training host 1402 may be deployed at a model server.

In some aspects, an ML model is deployed at or on a network entity (such as a base station 140 or a network entity 105) for supporting packet duplication of PDU packets. More specifically, a model interference host, such as model inference host 1404 in FIG. 14, may be deployed at or on the network entity 105 for such packet duplication, and selection of RLC legs for transmission of one or more instances of one or more packets.

In some other aspects, an ML model is deployed at or on a UE (such as UE 115) packet duplication of PDU packets. More specifically, a model inference host, such as model inference host 1404 in FIG. 14, may be deployed at or on the UE for such packet duplication, and selection of RLC legs for transmission of one or more instances of one or more packets.

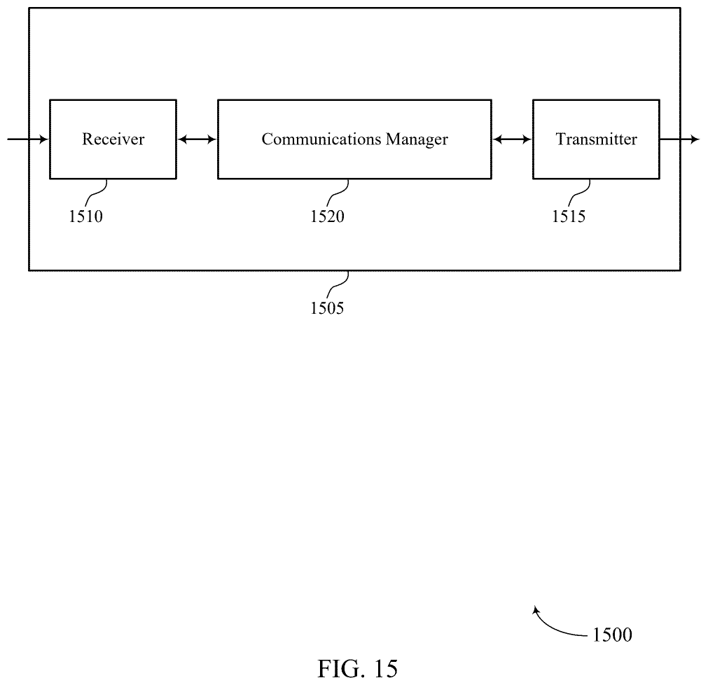

FIG. 15 shows a block diagram 1500 of a device 1505 that supports predictive packet duplication for wireless communication in accordance with one or more aspects of the present disclosure. The device 1505 may be an example of aspects of a UE 115 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to predictive packet duplication for wireless communication). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to predictive packet duplication for wireless communication). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations or components thereof may be examples of means for performing various aspects of predictive packet duplication for wireless communication as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication in accordance with examples as disclosed herein. For example, the communications manager 1520 is capable of, configured to, or operable to support a means for receiving a message (e.g., a control message or a configuration message) indicating one or more packet duplication parameters for one or more packets associated with a packet data convergence protocol (PDCP) layer of a protocol stack of the UE. The communications manager 1520 is capable of, configured to, or operable to support a means for selecting, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet. The communications manager 1520 is capable of, configured to, or operable to support a means for transmitting the one or more instances of the first packet using the selected one or more radio link control legs.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for predictive packet duplication that may provide for reduced latency, improved communication reliability, improved user experience, reduced power consumption, and more efficient utilization of communication resources.

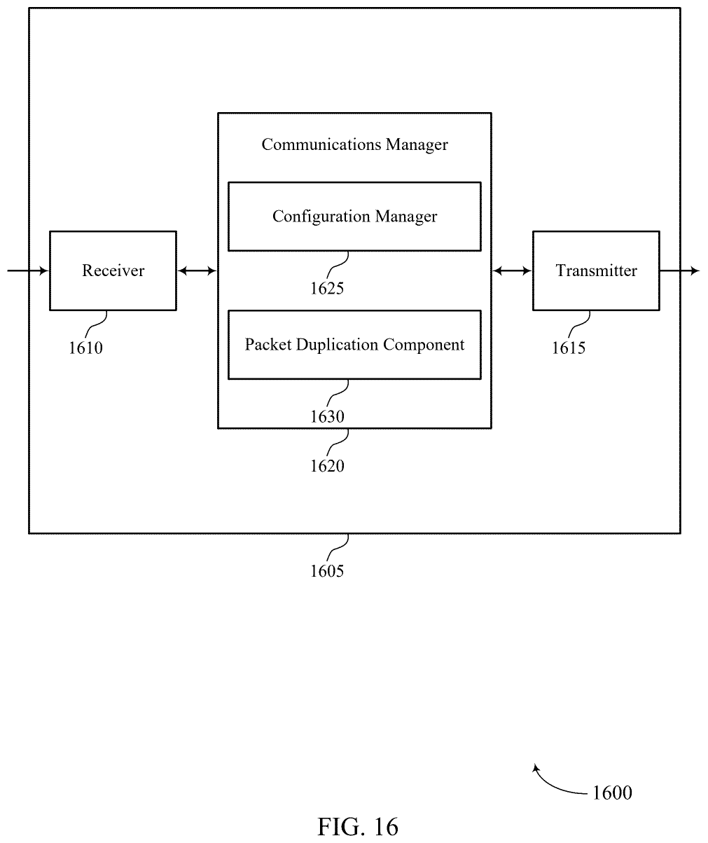

FIG. 16 shows a block diagram 1600 of a device 1605 that supports predictive packet duplication for wireless communication in accordance with one or more aspects of the present disclosure. The device 1605 may be an example of aspects of a device 1505 or a UE 115 as described herein. The device 1605 may include a receiver 1610, a transmitter 1615, and a communications manager 1620. The device 1605, or one of more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for receiving information such as packets, user data, control information, or any combination thereof associated with various information channels (e.g., control channels, data channels, information channels related to predictive packet duplication for wireless communication). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to predictive packet duplication for wireless communication). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of predictive packet duplication for wireless communication as described herein. For example, the communications manager 1620 may include a configuration manager 1625 a packet duplication component 1630, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communication in accordance with examples as disclosed herein. The configuration manager 1625 is capable of, configured to, or operable to support a means for receiving a message indicating one or more packet duplication parameters for one or more packets associated with a packet data convergence protocol (PDCP) layer of a protocol stack of the UE. The packet duplication component 1630 is capable of, configured to, or operable to support a means for selecting, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet. The packet duplication component 1630 is capable of, configured to, or operable to support a means for transmitting the one or more instances of the first packet using the selected one or more radio link control legs.

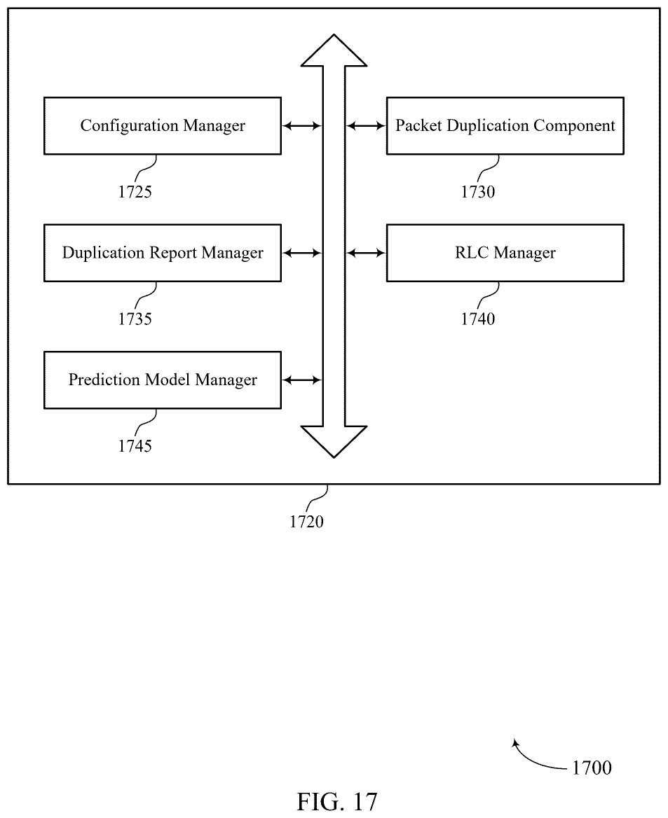

FIG. 17 shows a block diagram 1700 of a communications manager 1720 that supports predictive packet duplication for wireless communication in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of predictive packet duplication for wireless communication as described herein. For example, the communications manager 1720 may include a configuration manager 1725, a packet duplication component 1730, a duplication report manager 1735, an RLC manager 1740, a prediction model manager 1745, or any combination thereof. Each of these components, or components or subcomponents thereof (e.g., one or more processors, one or more memories), may communicate, directly or indirectly, with one another (e.g., via one or more buses).

The communications manager 1720 may support wireless communication in accordance with examples as disclosed herein. The configuration manager 1725 is capable of, configured to, or operable to support a means for receiving a message indicating one or more packet duplication parameters for one or more packets associated with a packet data convergence protocol (PDCP) layer of a protocol stack of the UE. The packet duplication component 1730 is capable of, configured to, or operable to support a means for selecting, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet. In some examples, the packet duplication component 1730 is capable of, configured to, or operable to support a means for transmitting the one or more instances of the first packet using the selected one or more radio link control legs.

In some examples, the one or more packet duplication parameters include an identification of the set of multiple radio link control legs and an indication that the packet duplication selection procedure is to be used at the UE to select the one or more radio link control legs based on one or more predicted values associated with the one or more packet duplication parameters. In some examples, the one or more packet duplication parameters include one or more performance metrics related to one or more of a predicted error rate associated with the first packet, a predicted latency associated with the first packet, an amount of usage of one or more radio link control legs associated with a duplicated instance of the first packet, or a limit on consecutive errors on the one or more radio link control legs.

In some examples, the duplication report manager 1735 is capable of, configured to, or operable to support a means for transmitting a duplication statistics report that includes one or more usage parameters associated with duplicated packets transmitted from the UE and utilization of one or more radio link control legs used for transmission of the duplicated packets.

In some examples, the message further indicates whether packet duplication is enabled or disabled at the UE. In some examples, the one or more radio link control legs include a primary radio link control leg and one or more secondary radio link control legs, and where a first instance of the first packet is transmitted on the primary radio link control leg and a second instance of the first packet is transmitted on a first radio link control leg that is selected from the one or more secondary radio link control legs based on the packet duplication selection procedure that indicates whether to duplicate the first packet, a number of instances of the first packet that are to be transmitted, and which of the one or more secondary radio link control legs to use for duplicate instances of the first packet. In some examples, the packet duplication selection procedure outputs an indication of whether packet duplication of the one or more packets is enabled and an indication of the selected one or more radio link control legs, and where the indication is applied to all packets of the one or more packets or is applied on a per-packet basis for each of the one or more packets.

In some examples, the prediction model manager 1745 is capable of, configured to, or operable to support a means for providing, to a prediction model associated with the packet duplication selection procedure, one or more of a channel condition associated with a radio channel used for transmission of the one or more packets, a reliability target associated with the one or more packets, a latency target associated with the one or more packets, a state associated with traffic flow associated with the one or more packets, a state associated with the UE, or a usage limit for at least one of the set of multiple radio link control legs. In some examples, the one or more packet duplication parameters include one or more of a latency target associated with the one or more packets, a reliability target associated with the one or more packets, or a throughput target associated with the one or more packets.

In some examples, the packet duplication component 1730 is capable of, configured to, or operable to support a means for transmitting an indication of the selected one or more radio link control legs in one or more of a PDCP header provided with the first packet, a control packet associated with the first packet, or a duplication medium access control (MAC) control element.

In some examples, the duplication report manager 1735 is capable of, configured to, or operable to support a means for transmitting a PDCP duplication report that includes one or more of a log of radio link control legs used for transmission of the one or more packets, a log of failed packet transmissions, usage information for each of the one or more radio link control legs, an indication of a quantity of packets transmitted using two or more different duplication factors, an indication of one or more parameters that prompted transmission of at least two instances for at least one of the one or more packets, or performance statistics associated with one or more performance metrics.

In some examples, the configuration manager 1725 is capable of, configured to, or operable to support a means for transmitting a capability message that provides an indication of a capability of the UE to perform the packet duplication selection procedure. In some examples, to support receiving the message, the configuration manager 1725 is capable of, configured to, or operable to support a means for receiving a radio resource control configuration message that includes one or more key performance indicators (KPIs), performance targets, a link failure threshold parameter associated with the one or more radio link control legs, a usage threshold parameter associated with the one or more radio link control legs, or any combination thereof. In some examples, the radio resource control configuration message further indicates one or more of whether to enable or disable usage of the packet duplication selection procedure, one or more quality of service (QOS) flows on which to enable or disable usage of the packet duplication selection procedure, a loss target over all radio link control legs, a quantity of consecutive errors associated with the one or more radio link control legs, a latency limit across the one or more radio link control legs, or any combination thereof.

In some examples, the packet duplication component 1730 is capable of, configured to, or operable to support a means for initiating a packet duplication fallback procedure based on a performance metric target associated with the packet duplication selection procedure being unmet, where the packet duplication fallback procedure includes one or more of performing packet duplication according to a fallback packet duplication state, transmitting a performance metric violation report as part of performance reporting, or discontinuing use of the packet duplication selection procedure for a radio bearer or packet flow associated with the one or more packets.

In some examples, the RLC manager 1740 is capable of, configured to, or operable to support a means for receiving a medium access control (MAC) duplication message that indicates a set of radio link control legs to be used to transmit at least a second packet of the one or more packets. In some examples, the RLC manager 1740 is capable of, configured to, or operable to support a means for transmitting the second packet using the set of radio link control legs.

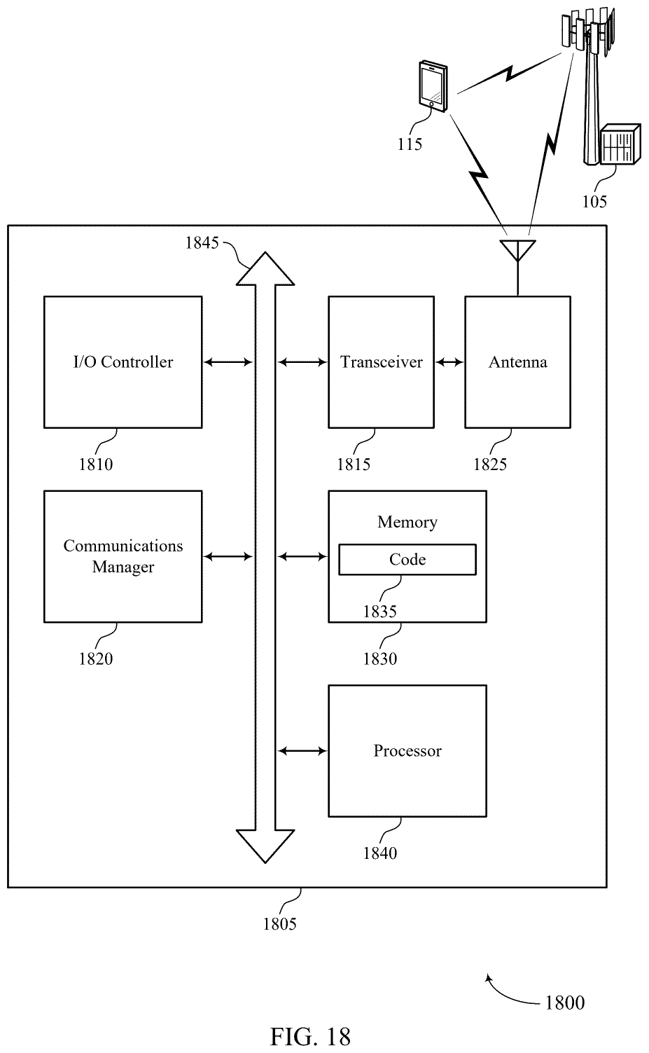

FIG. 18 shows a diagram of a system 1800 including a device 1805 that supports predictive packet duplication for wireless communication in accordance with one or more aspects of the present disclosure. The device 1805 may be an example of or include components of a device 1505, a device 1605, or a UE 115 as described herein. The device 1805 may communicate (e.g., wirelessly) with one or more other devices (e.g., network entities 105, UEs 115, or a combination thereof). The device 1805 may include components for bi-directional voice and data communications including components for transmitting and receiving communications, such as a communications manager 1820, an input/output (I/O) controller, such as an I/O controller 1810, a transceiver 1815, one or more antennas 1825, at least one memory 1830, code 1835, and at least one processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DOS®, MS-WINDOWS®, OS/2®, UNIX®, LINUX®, or another known operating system. Additionally, or alternatively, the I/O controller 1810 may represent or interact with a modem, a keyboard, a mouse, a touchscreen, or a similar device. In some cases, the I/O controller 1810 may be implemented as part of one or more processors, such as the at least one processor 1840. In some cases, a user may interact with the device 1805 via the I/O controller 1810 or via hardware components controlled by the I/O controller 1810.

In some cases, the device 1805 may include a single antenna. However, in some other cases, the device 1805 may have more than one antenna, which may be capable of concurrently transmitting or receiving multiple wireless transmissions. The transceiver 1815 may communicate bi-directionally via the one or more antennas 1825 using wired or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The at least one memory 1830 may include random access memory (RAM) and read-only memory (ROM). The at least one memory 1830 may store computer-readable, computer-executable, or processor-executable code, such as the code 1835. The code 1835 may include instructions that, when executed by the at least one processor 1840, cause the device 1805 to perform various functions described herein. The code 1835 may be stored in a non-transitory computer-readable medium such as system memory or another type of memory. In some cases, the code 1835 may not be directly executable by the at least one processor 1840 but may cause a computer (e.g., when compiled and executed) to perform functions described herein. In some cases, the at least one memory 1830 may include, among other things, a basic I/O system (BIOS) which may control basic hardware or software operation such as the interaction with peripheral components or devices.

The at least one processor 1840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1840 may be configured to operate a memory array using a memory controller. In some other cases, a memory controller may be integrated into the at least one processor 1840. The at least one processor 1840 may be configured to execute computer-readable instructions stored in a memory (e.g., the at least one memory 1830) to cause the device 1805 to perform various functions (e.g., functions or tasks supporting predictive packet duplication for wireless communication). For example, the device 1805 or a component of the device 1805 may include at least one processor 1840 and at least one memory 1830 coupled with or to the at least one processor 1840, the at least one processor 1840 and the at least one memory 1830 configured to perform various functions described herein.

In some examples, the at least one processor 1840 may include multiple processors and the at least one memory 1830 may include multiple memories. One or more of the multiple processors may be coupled with one or more of the multiple memories, which may, individually or collectively, be configured to perform various functions described herein. In some examples, the at least one processor 1840 may be a component of a processing system, which may refer to a system (such as a series) of machines, circuitry (including, for example, one or both of processor circuitry (which may include the at least one processor 1840) and memory circuitry (which may include the at least one memory 1830)), or components, that receives or obtains inputs and processes the inputs to produce, generate, or obtain a set of outputs. The processing system may be configured to perform one or more of the functions described herein. For example, the at least one processor 1840 or a processing system including the at least one processor 1840 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code 1835 (e.g., processor-executable code) stored in the at least one memory 1830 or otherwise, to perform one or more of the functions described herein.

The communications manager 1820 may support wireless communication in accordance with examples as disclosed herein. For example, the communications manager 1820 is capable of, configured to, or operable to support a means for receiving a message indicating one or more packet duplication parameters for one or more packets associated with a packet data convergence protocol (PDCP) layer of a protocol stack of the UE. The communications manager 1820 is capable of, configured to, or operable to support a means for selecting, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet. The communications manager 1820 is capable of, configured to, or operable to support a means for transmitting the one or more instances of the first packet using the selected one or more radio link control legs.

By including or configuring the communications manager 1820 in accordance with examples as described herein, the device 1805 may support techniques for predictive packet duplication that may provide for reduced latency, improved communication reliability, improved user experience, reduced power consumption, and more efficient utilization of communication resources.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the at least one processor 1840, the at least one memory 1830, the code 1835, or any combination thereof. For example, the code 1835 may include instructions executable by the at least one processor 1840 to cause the device 1805 to perform various aspects of predictive packet duplication for wireless communication as described herein, or the at least one processor 1840 and the at least one memory 1830 may be otherwise configured to, individually or collectively, perform or support such operations.

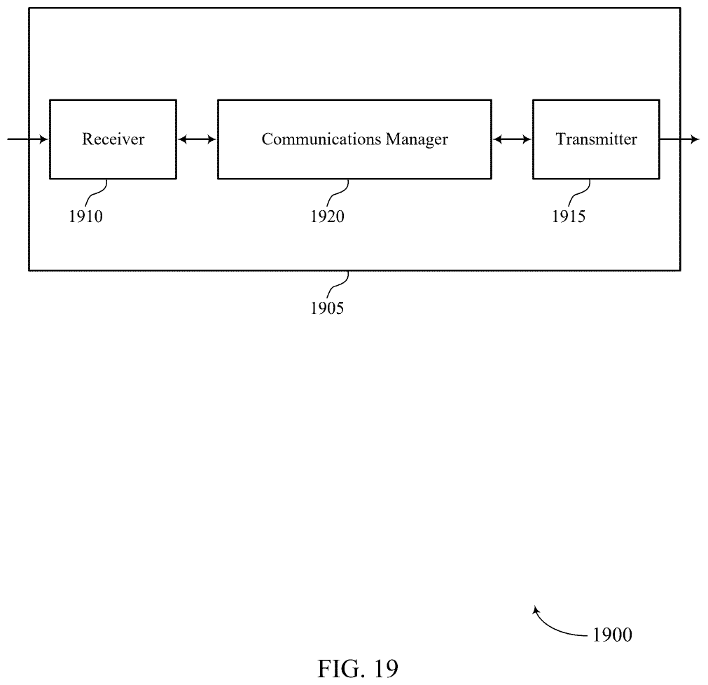

FIG. 19 shows a block diagram 1900 of a device 1905 that supports predictive packet duplication for wireless communication in accordance with one or more aspects of the present disclosure. The device 1905 may be an example of aspects of a network entity 105 as described herein. The device 1905 may include a receiver 1910, a transmitter 1915, and a communications manager 1920. The device 1905, or one or more components of the device 1905 (e.g., the receiver 1910, the transmitter 1915, the communications manager 1920), may include at least one processor, which may be coupled with at least one memory, to, individually or collectively, support or enable the described techniques. Each of these components may be in communication with one another (e.g., via one or more buses).

The receiver 1910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1905. In some examples, the receiver 1910 may support obtaining information by receiving signals via one or more antennas. Additionally, or alternatively, the receiver 1910 may support obtaining information by receiving signals via one or more wired (e.g., electrical, fiber optic) interfaces, wireless interfaces, or any combination thereof.

The transmitter 1915 may provide a means for outputting (e.g., transmitting, providing, conveying, sending) information generated by other components of the device 1905. For example, the transmitter 1915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1915 may support outputting information by transmitting signals via one or more antennas. Additionally, or alternatively, the transmitter 1915 may support outputting information by transmitting signals via one or more wired (e.g., electrical, fiber optic) interfaces, wireless interfaces, or any combination thereof. In some examples, the transmitter 1915 and the receiver 1910 may be co-located in a transceiver, which may include or be coupled with a modem.

The communications manager 1920, the receiver 1910, the transmitter 1915, or various combinations or components thereof may be examples of means for performing various aspects of predictive packet duplication for wireless communication as described herein. For example, the communications manager 1920, the receiver 1910, the transmitter 1915, or various combinations or components thereof may be capable of performing one or more of the functions described herein.

In some examples, the communications manager 1920, the receiver 1910, the transmitter 1915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1920, the receiver 1910, the transmitter 1915, or various combinations or components thereof may be implemented in code (e.g., as communications management software or firmware) executed by at least one processor (e.g., referred to as a processor-executable code). If implemented in code executed by at least one processor, the functions of the communications manager 1920, the receiver 1910, the transmitter 1915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1920 may be configured to perform various operations (e.g., receiving, obtaining, monitoring, outputting, transmitting) using or otherwise in cooperation with the receiver 1910, the transmitter 1915, or both. For example, the communications manager 1920 may receive information from the receiver 1910, send information to the transmitter 1915, or be integrated in combination with the receiver 1910, the transmitter 1915, or both to obtain information, output information, or perform various other operations as described herein.

The communications manager 1920 may support wireless communication in accordance with examples as disclosed herein. For example, the communications manager 1920 is capable of, configured to, or operable to support a means for transmitting, to a UE, a message indicating one or more packet duplication parameters for one or more packets associated with a packet data convergence protocol (PDCP) layer of a protocol stack of the UE, the one or more packet duplication parameters indicating that a packet duplication selection procedure is to be used at the UE for selection of one or more radio link control legs of a set of multiple radio link control legs at the UE for transmission of the one or more packets. The communications manager 1920 is capable of, configured to, or operable to support a means for obtaining, from the UE, one or more instances of at least a first packet of the one or more packets.

By including or configuring the communications manager 1920 in accordance with examples as described herein, the device 1905 (e.g., at least one processor controlling or otherwise coupled with the receiver 1910, the transmitter 1915, the communications manager 1920, or a combination thereof) may support techniques for predictive packet duplication that may provide for reduced latency, improved communication reliability, improved user experience, reduced power consumption, and more efficient utilization of communication resources.

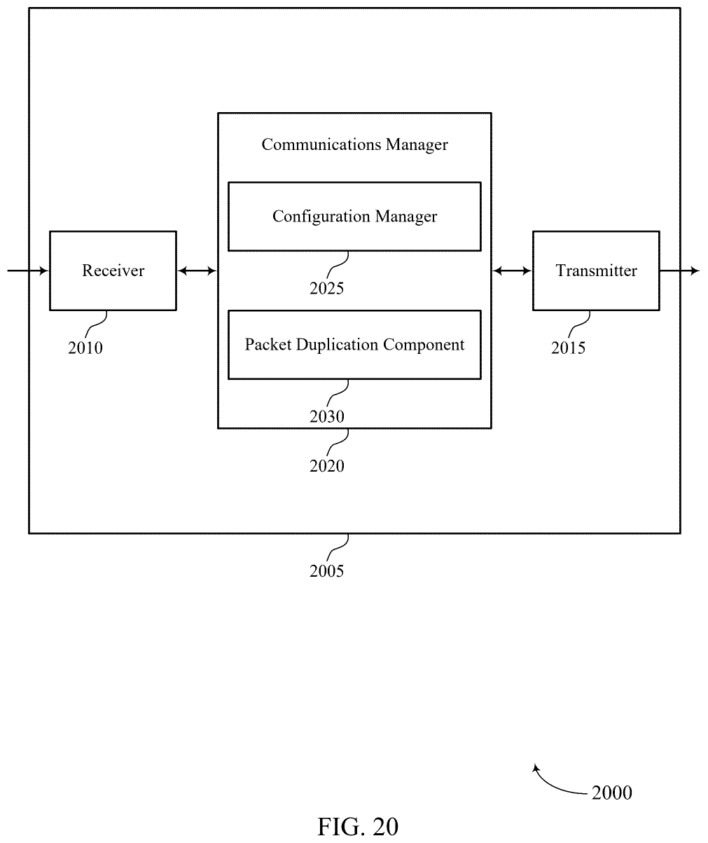

FIG. 20 shows a block diagram 2000 of a device 2005 that supports predictive packet duplication for wireless communication in accordance with one or more aspects of the present disclosure. The device 2005 may be an example of aspects of a device 1905 or a network entity 105 as described herein. The device 2005 may include a receiver 2010, a transmitter 2015, and a communications manager 2020. The device 2005, or one of more components of the device 2005 (e.g., the receiver 2010, the transmitter 2015, the communications manager 2020), may include at least one processor, which may be coupled with at least one memory, to support the described techniques. Each of these components may be in communication with one another (e.g., via one or more buses).

The receiver 2010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 2005. In some examples, the receiver 2010 may support obtaining information by receiving signals via one or more antennas. Additionally, or alternatively, the receiver 2010 may support obtaining information by receiving signals via one or more wired (e.g., electrical, fiber optic) interfaces, wireless interfaces, or any combination thereof.

The transmitter 2015 may provide a means for outputting (e.g., transmitting, providing, conveying, sending) information generated by other components of the device 2005. For example, the transmitter 2015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 2015 may support outputting information by transmitting signals via one or more antennas. Additionally, or alternatively, the transmitter 2015 may support outputting information by transmitting signals via one or more wired (e.g., electrical, fiber optic) interfaces, wireless interfaces, or any combination thereof. In some examples, the transmitter 2015 and the receiver 2010 may be co-located in a transceiver, which may include or be coupled with a modem.

The device 2005, or various components thereof, may be an example of means for performing various aspects of predictive packet duplication for wireless communication as described herein. For example, the communications manager 2020 may include a configuration manager 2025 a packet duplication component 2030, or any combination thereof. The communications manager 2020 may be an example of aspects of a communications manager 1920 as described herein. In some examples, the communications manager 2020, or various components thereof, may be configured to perform various operations (e.g., receiving, obtaining, monitoring, outputting, transmitting) using or otherwise in cooperation with the receiver 2010, the transmitter 2015, or both. For example, the communications manager 2020 may receive information from the receiver 2010, send information to the transmitter 2015, or be integrated in combination with the receiver 2010, the transmitter 2015, or both to obtain information, output information, or perform various other operations as described herein.

The communications manager 2020 may support wireless communication in accordance with examples as disclosed herein. The configuration manager 2025 is capable of, configured to, or operable to support a means for transmitting, to a UE, a message indicating one or more packet duplication parameters for one or more packets associated with a packet data convergence protocol (PDCP) layer of a protocol stack of the UE, the one or more packet duplication parameters indicating that a packet duplication selection procedure is to be used at the UE for selection of one or more radio link control legs of a set of multiple radio link control legs at the UE for transmission of the one or more packets. The packet duplication component 2030 is capable of, configured to, or operable to support a means for obtaining, from the UE, one or more instances of at least a first packet of the one or more packets.

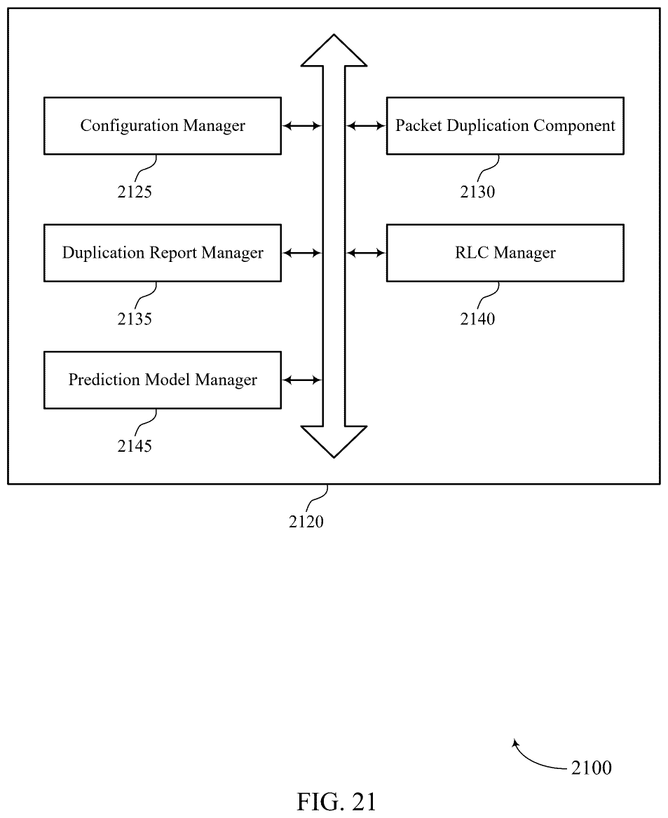

FIG. 21 shows a block diagram 2100 of a communications manager 2120 that supports predictive packet duplication for wireless communication in accordance with one or more aspects of the present disclosure. The communications manager 2120 may be an example of aspects of a communications manager 1920, a communications manager 2020, or both, as described herein. The communications manager 2120, or various components thereof, may be an example of means for performing various aspects of predictive packet duplication for wireless communication as described herein. For example, the communications manager 2120 may include a configuration manager 2125, a packet duplication component 2130, a duplication report manager 2135, an RLC manager 2140, a prediction model manager 2145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 2120 may support wireless communication in accordance with examples as disclosed herein. The configuration manager 2125 is capable of, configured to, or operable to support a means for transmitting, to a UE, a message indicating one or more packet duplication parameters for one or more packets associated with a packet data convergence protocol (PDCP) layer of a protocol stack of the UE, the one or more packet duplication parameters indicating that a packet duplication selection procedure is to be used at the UE for selection of one or more radio link control legs of a set of multiple radio link control legs at the UE for transmission of the one or more packets. The packet duplication component 2130 is capable of, configured to, or operable to support a means for obtaining, from the UE, one or more instances of at least a first packet of the one or more packets.

In some examples, the one or more packet duplication parameters include an identification of the set of multiple radio link control legs and an indication that the packet duplication selection procedure is to be used at the UE to select the one or more radio link control legs based on one or more predicted values associated with the one or more packet duplication parameters. In some examples, the one or more packet duplication parameters include one or more performance metrics related to one or more of a predicted error rate associated with the first packet, a predicted latency associated with the first packet, an amount of usage of one or more radio link control legs associated with a duplicated instance of the first packet, or a limit on consecutive errors on the one or more radio link control legs.

In some examples, the duplication report manager 2135 is capable of, configured to, or operable to support a means for obtaining, from the UE, a duplication statistics report that includes one or more usage parameters associated with duplicated packets transmitted from the UE and utilization of one or more radio link control legs used for transmission of the duplicated packets.

In some examples, the message further indicates whether packet duplication is enabled or disabled at the UE. In some examples, the one or more radio link control legs include a primary radio link control leg and one or more secondary radio link control legs, and where a first instance of the first packet is transmitted on the primary radio link control leg and a second instance of the first packet is transmitted on a first radio link control leg that is selected from the one or more secondary radio link control legs based on the packet duplication selection procedure that indicates whether to duplicate the first packet, a number of instances of the first packet that are to be transmitted, and which of the one or more secondary radio link control legs to use for duplicate instances of the first packet. In some examples, the packet duplication parameters configure the packet duplication selection procedure to output an indication of whether packet duplication of the one or more packets is enabled and an indication of the selected one or more radio link control legs, and where the indication is applied to all packets of the one or more packets or is applied on a per-packet basis for each of the one or more packets. In some examples, the packet duplication parameters configure a prediction model associated with the packet duplication selection procedure, and where inputs to the prediction model include one or more of a channel condition associated with a radio channel used for transmission of the one or more packets, a reliability target associated with the one or more packets, a latency target associated with the one or more packets, a state associated with traffic flow associated with the one or more packets, a state associated with the UE, or a usage limit for at least one of the set of multiple radio link control legs.

In some examples, the packet duplication component 2130 is capable of, configured to, or operable to support a means for obtaining an indication from the UE of a quantity of instances of the first packet that are transmitted, where the indication is received in one or more of a PDCP header provided with an initial instance the first packet, a control packet associated with the first packet, or a duplication medium access control (MAC) control element.

In some examples, the duplication report manager 2135 is capable of, configured to, or operable to support a means for obtaining a PDCP duplication report from the UE that includes one or more of a log of radio link control legs used for transmission of the one or more packets, a log of failed packet transmissions, usage information for each of the one or more radio link control legs, an indication of a quantity of packets transmitted using two or more different duplication factors, an indication of one or more parameters that prompted transmission of at least two instances for at least one of the one or more packets, or performance statistics associated with one or more performance metrics.

In some examples, the configuration manager 2125 is capable of, configured to, or operable to support a means for obtaining a capability message from the UE that provides an indication of a capability of the UE to perform the packet duplication selection procedure, and where the one or more packet duplication parameters are selected based on the capability of the UE to perform the packet duplication selection procedure.

In some examples, to support transmitting the message, the configuration manager 2125 is capable of, configured to, or operable to support a means for outputting a radio resource control configuration message that includes one or more key performance indicators (KPIs), performance targets, a link failure threshold parameter associated with the one or more radio link control legs, a usage threshold parameter associated with the one or more radio link control legs, or any combination thereof.

In some examples, the packet duplication component 2130 is capable of, configured to, or operable to support a means for configuring the UE with a packet duplication fallback procedure that is to be initiated based on a performance metric target associated with the packet duplication selection procedure being unmet, where the packet duplication fallback procedure includes one or more of performing packet duplication according to a fallback packet duplication state, transmitting a performance metric violation report as part of performance reporting, or discontinuing use of the packet duplication selection procedure for a radio bearer or packet flow associated with the one or more packets.

In some examples, the RLC manager 2140 is capable of, configured to, or operable to support a means for outputting a medium access control (MAC) duplication message to the UE that indicates a set of radio link control legs to be used to transmit at least a second packet of the one or more packets. In some examples, the RLC manager 2140 is capable of, configured to, or operable to support a means for obtaining one or more instances of the second packet in accordance with the MAC duplication message.

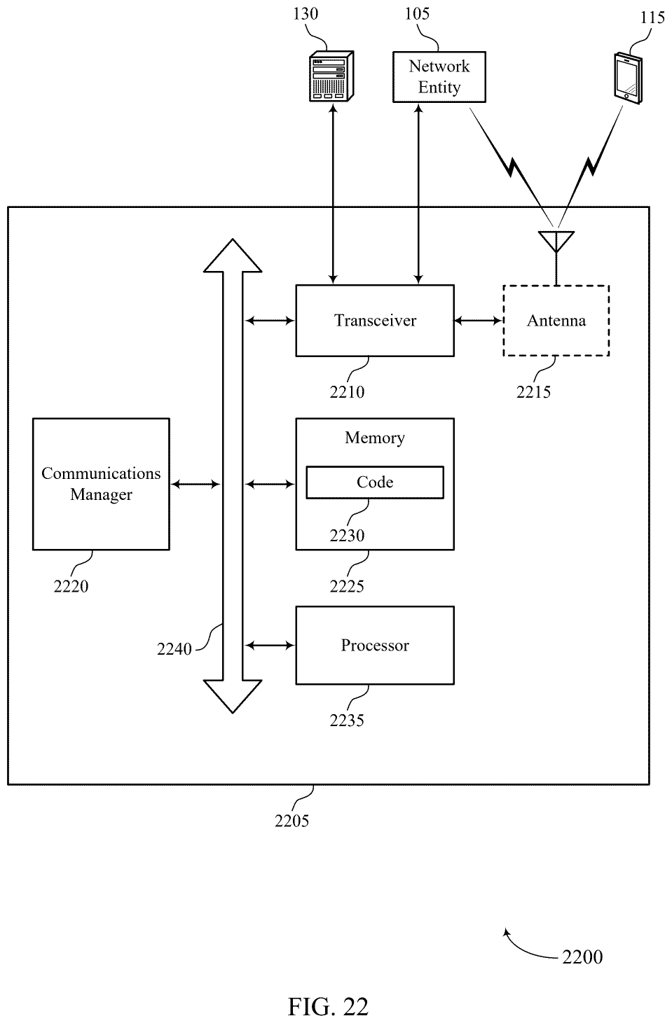

FIG. 22 shows a diagram of a system 2200 including a device 2205 that supports predictive packet duplication for wireless communication in accordance with one or more aspects of the present disclosure. The device 2205 may be an example of or include components of a device 1905, a device 2005, or a network entity 105 as described herein. The device 2205 may communicate with other network devices or network equipment such as one or more of the network entities 105, UEs 115, or any combination thereof. The communications may include communications over one or more wired interfaces, over one or more wireless interfaces, or any combination thereof. The device 2205 may include components that support outputting and obtaining communications, such as a communications manager 2220, a transceiver 2210, one or more antennas 2215, at least one memory 2225, code 2230, and at least one processor 2235. These components may be in electronic communication or otherwise coupled (e.g., operatively, communicatively, functionally, electronically, electrically) via one or more buses (e.g., a bus 2240).

The transceiver 2210 may support bi-directional communications via wired links, wireless links, or both as described herein. In some examples, the transceiver 2210 may include a wired transceiver and may communicate bi-directionally with another wired transceiver. Additionally, or alternatively, in some examples, the transceiver 2210 may include a wireless transceiver and may communicate bi-directionally with another wireless transceiver. In some examples, the device 2205 may include one or more antennas 2215, which may be capable of transmitting or receiving wireless transmissions (e.g., concurrently). The transceiver 2210 may also include a modem to modulate signals, to provide the modulated signals for transmission (e.g., by one or more antennas 2215, by a wired transmitter), to receive modulated signals (e.g., from one or more antennas 2215, from a wired receiver), and to demodulate signals. In some implementations, the transceiver 2210 may include one or more interfaces, such as one or more interfaces coupled with the one or more antennas 2215 that are configured to support various receiving or obtaining operations, or one or more interfaces coupled with the one or more antennas 2215 that are configured to support various transmitting or outputting operations, or a combination thereof. In some implementations, the transceiver 2210 may include or be configured for coupling with one or more processors or one or more memory components that are operable to perform or support operations based on received or obtained information or signals, or to generate information or other signals for transmission or other outputting, or any combination thereof. In some implementations, the transceiver 2210, or the transceiver 2210 and the one or more antennas 2215, or the transceiver 2210 and the one or more antennas 2215 and one or more processors or one or more memory components (e.g., the at least one processor 2235, the at least one memory 2225, or both), may be included in a chip or chip assembly that is installed in the device 2205. In some examples, the transceiver 2210 may be operable to support communications via one or more communications links (e.g., communication link(s) 125, backhaul communication link(s) 120, a midhaul communication link 162, a fronthaul communication link 168).

The at least one memory 2225 may include RAM, ROM, or any combination thereof. The at least one memory 2225 may store computer-readable, computer-executable, or processor-executable code, such as the code 2230. The code 2230 may include instructions that, when executed by one or more of the at least one processor 2235, cause the device 2205 to perform various functions described herein. The code 2230 may be stored in a non-transitory computer-readable medium such as system memory or another type of memory. In some cases, the code 2230 may not be directly executable by a processor of the at least one processor 2235 but may cause a computer (e.g., when compiled and executed) to perform functions described herein. In some cases, the at least one memory 2225 may include, among other things, a BIOS which may control basic hardware or software operation such as the interaction with peripheral components or devices. In some examples, the at least one processor 2235 may include multiple processors and the at least one memory 2225 may include multiple memories. One or more of the multiple processors may be coupled with one or more of the multiple memories which may, individually or collectively, be configured to perform various functions herein (for example, as part of a processing system).

The at least one processor 2235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 2235 may be configured to operate a memory array using a memory controller. In some other cases, a memory controller may be integrated into one or more of the at least one processor 2235. The at least one processor 2235 may be configured to execute computer-readable instructions stored in a memory (e.g., one or more of the at least one memory 2225) to cause the device 2205 to perform various functions (e.g., functions or tasks supporting predictive packet duplication for wireless communication). For example, the device 2205 or a component of the device 2205 may include at least one processor 2235 and at least one memory 2225 coupled with one or more of the at least one processor 2235, the at least one processor 2235 and the at least one memory 2225 configured to perform various functions described herein. The at least one processor 2235 may be an example of a cloud-computing platform (e.g., one or more physical nodes and supporting software such as operating systems, virtual machines, or container instances) that may host the functions (e.g., by executing code 2230) to perform the functions of the device 2205. The at least one processor 2235 may be any one or more suitable processors capable of executing scripts or instructions of one or more software programs stored in the device 2205 (such as within one or more of the at least one memory 2225).

In some examples, the at least one processor 2235 may include multiple processors and the at least one memory 2225 may include multiple memories. One or more of the multiple processors may be coupled with one or more of the multiple memories, which may, individually or collectively, be configured to perform various functions herein. In some examples, the at least one processor 2235 may be a component of a processing system, which may refer to a system (such as a series) of machines, circuitry (including, for example, one or both of processor circuitry (which may include the at least one processor 2235) and memory circuitry (which may include the at least one memory 2225)), or components, that receives or obtains inputs and processes the inputs to produce, generate, or obtain a set of outputs. The processing system may be configured to perform one or more of the functions described herein. For example, the at least one processor 2235 or a processing system including the at least one processor 2235 may be configured to, configurable to, or operable to cause the device 2205 to perform one or more of the functions described herein. Further, as described herein, being “configured to,” being “configurable to,” and being “operable to” may be used interchangeably and may be associated with a capability, when executing code stored in the at least one memory 2225 or otherwise, to perform one or more of the functions described herein.

In some examples, a bus 2240 may support communications of (e.g., within) a protocol layer of a protocol stack. In some examples, a bus 2240 may support communications associated with a logical channel of a protocol stack (e.g., between protocol layers of a protocol stack), which may include communications performed within a component of the device 2205, or between different components of the device 2205 that may be co-located or located in different locations (e.g., where the device 2205 may refer to a system in which one or more of the communications manager 2220, the transceiver 2210, the at least one memory 2225, the code 2230, and the at least one processor 2235 may be located in one of the different components or divided between different components).

In some examples, the communications manager 2220 may manage aspects of communications with a core network 130 (e.g., via one or more wired or wireless backhaul links). For example, the communications manager 2220 may manage the transfer of data communications for client devices, such as one or more UEs 115. In some examples, the communications manager 2220 may manage communications with one or more other network entities 105, and may include a controller or scheduler for controlling communications with UEs 115 (e.g., in cooperation with the one or more other network devices). In some examples, the communications manager 2220 may support an X2 interface within an LTE/LTE-A wireless communications network technology to provide communication between network entities 105.

The communications manager 2220 may support wireless communication in accordance with examples as disclosed herein. For example, the communications manager 2220 is capable of, configured to, or operable to support a means for transmitting, to a UE, a message indicating one or more packet duplication parameters for one or more packets associated with a packet data convergence protocol (PDCP) layer of a protocol stack of the UE, the one or more packet duplication parameters indicating that a packet duplication selection procedure is to be used at the UE for selection of one or more radio link control legs of a set of multiple radio link control legs at the UE for transmission of the one or more packets. The communications manager 2220 is capable of, configured to, or operable to support a means for obtaining, from the UE, one or more instances of at least a first packet of the one or more packets.

By including or configuring the communications manager 2220 in accordance with examples as described herein, the device 2205 may support techniques for predictive packet duplication that may provide for reduced latency, improved communication reliability, improved user experience, reduced power consumption, and more efficient utilization of communication resources.

In some examples, the communications manager 2220 may be configured to perform various operations (e.g., receiving, obtaining, monitoring, outputting, transmitting) using or otherwise in cooperation with the transceiver 2210, the one or more antennas 2215 (e.g., where applicable), or any combination thereof. Although the communications manager 2220 is illustrated as a separate component, in some examples, one or more functions described with reference to the communications manager 2220 may be supported by or performed by the transceiver 2210, one or more of the at least one processor 2235, one or more of the at least one memory 2225, the code 2230, or any combination thereof (for example, by a processing system including at least a portion of the at least one processor 2235, the at least one memory 2225, the code 2230, or any combination thereof). For example, the code 2230 may include instructions executable by one or more of the at least one processor 2235 to cause the device 2205 to perform various aspects of predictive packet duplication for wireless communication as described herein, or the at least one processor 2235 and the at least one memory 2225 may be otherwise configured to, individually or collectively, perform or support such operations.

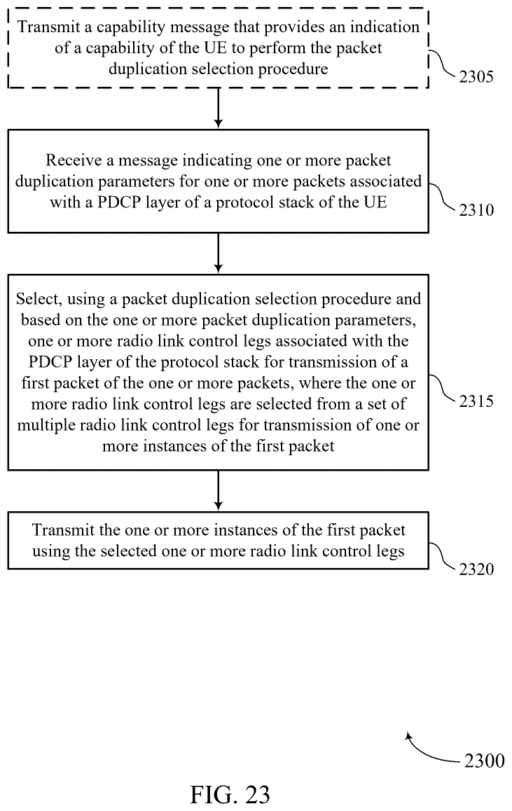

FIG. 23 shows a flowchart illustrating a method 2300 that supports predictive packet duplication for wireless communication in accordance with one or more aspects of the present disclosure. The operations of the method 2300 may be implemented by a UE or its components as described herein. For example, the operations of the method 2300 may be performed by a UE 115 as described with reference to FIGS. 1 through 18. In some examples, a UE may execute a set of instructions to control the functional elements of the UE to perform the described functions. Additionally, or alternatively, the UE may perform aspects of the described functions using special-purpose hardware.

Optionally, at 2305, the method may include transmitting a capability message that provides an indication of a capability of the UE to perform the packet duplication selection procedure. The operations of 2305 may be performed in accordance with examples as disclosed herein. In some examples, aspects of the operations of 2305 may be performed by a configuration manager 1725 as described with reference to FIG. 17.

At 2310, the method may include receiving a message indicating one or more packet duplication parameters for one or more packets associated with a packet data convergence protocol (PDCP) layer of a protocol stack of the UE. The operations of 2310 may be performed in accordance with examples as disclosed herein. In some examples, aspects of the operations of 2310 may be performed by a configuration manager 1725 as described with reference to FIG. 17.

At 2315, the method may include selecting, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet. The operations of 2315 may be performed in accordance with examples as disclosed herein. In some examples, aspects of the operations of 2315 may be performed by a packet duplication component 1730 as described with reference to FIG. 17.

At 2320, the method may include transmitting the one or more instances of the first packet using the selected one or more radio link control legs. The operations of 2320 may be performed in accordance with examples as disclosed herein. In some examples, aspects of the operations of 2320 may be performed by a packet duplication component 1730 as described with reference to FIG. 17.

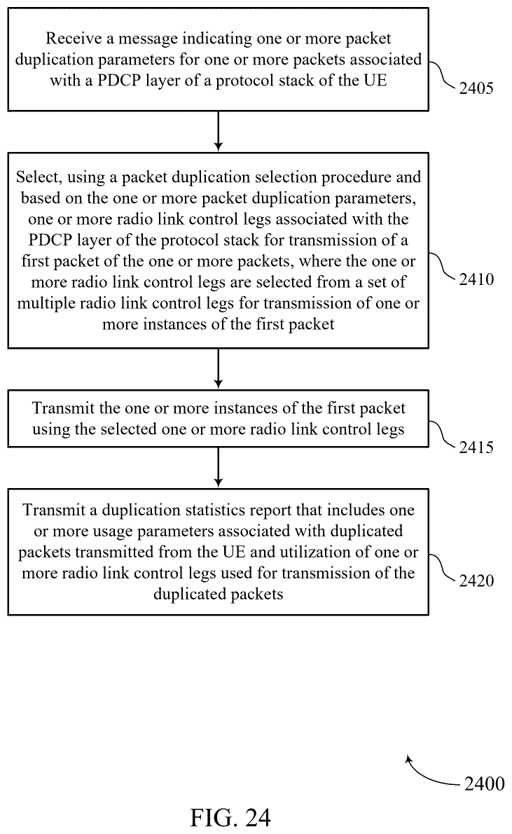

FIG. 24 shows a flowchart illustrating a method 2400 that supports predictive packet duplication for wireless communication in accordance with one or more aspects of the present disclosure. The operations of the method 2400 may be implemented by a UE or its components as described herein. For example, the operations of the method 2400 may be performed by a UE 115 as described with reference to FIGS. 1 through 18. In some examples, a UE may execute a set of instructions to control the functional elements of the UE to perform the described functions. Additionally, or alternatively, the UE may perform aspects of the described functions using special-purpose hardware.

At 2405, the method may include receiving a message indicating one or more packet duplication parameters for one or more packets associated with a packet data convergence protocol (PDCP) layer of a protocol stack of the UE. The operations of 2405 may be performed in accordance with examples as disclosed herein. In some examples, aspects of the operations of 2405 may be performed by a configuration manager 1725 as described with reference to FIG. 17.

At 2410, the method may include selecting, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet. The operations of 2410 may be performed in accordance with examples as disclosed herein. In some examples, aspects of the operations of 2410 may be performed by a packet duplication component 1730 as described with reference to FIG. 17.

At 2415, the method may include transmitting the one or more instances of the first packet using the selected one or more radio link control legs. The operations of 2415 may be performed in accordance with examples as disclosed herein. In some examples, aspects of the operations of 2415 may be performed by a packet duplication component 1730 as described with reference to FIG. 17.

At 2420, the method may include transmitting a duplication statistics report that includes one or more usage parameters associated with duplicated packets transmitted from the UE and utilization of one or more radio link control legs used for transmission of the duplicated packets. The operations of 2420 may be performed in accordance with examples as disclosed herein. In some examples, aspects of the operations of 2420 may be performed by a duplication report manager 1735 as described with reference to FIG. 17.

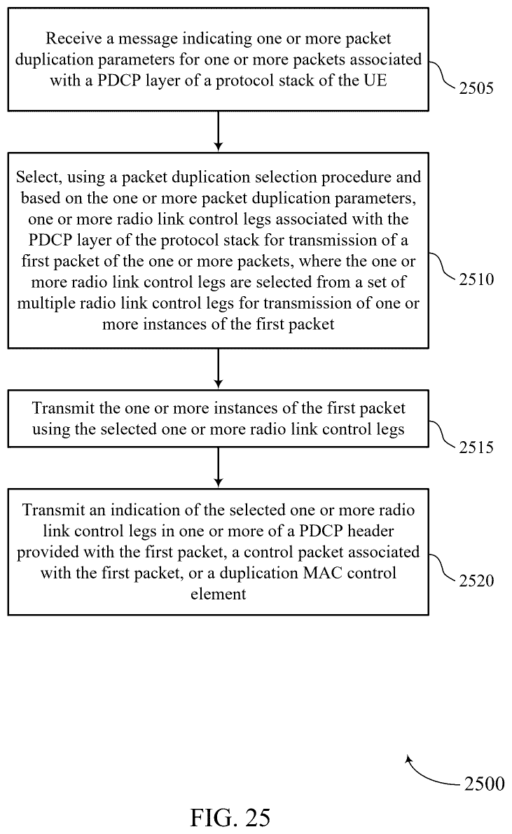

FIG. 25 shows a flowchart illustrating a method 2500 that supports predictive packet duplication for wireless communication in accordance with one or more aspects of the present disclosure. The operations of the method 2500 may be implemented by a UE or its components as described herein. For example, the operations of the method 2500 may be performed by a UE 115 as described with reference to FIGS. 1 through 18. In some examples, a UE may execute a set of instructions to control the functional elements of the UE to perform the described functions. Additionally, or alternatively, the UE may perform aspects of the described functions using special-purpose hardware.

At 2505, the method may include receiving a message indicating one or more packet duplication parameters for one or more packets associated with a packet data convergence protocol (PDCP) layer of a protocol stack of the UE. The operations of 2505 may be performed in accordance with examples as disclosed herein. In some examples, aspects of the operations of 2505 may be performed by a configuration manager 1725 as described with reference to FIG. 17.

At 2510, the method may include selecting, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet. The operations of 2510 may be performed in accordance with examples as disclosed herein. In some examples, aspects of the operations of 2510 may be performed by a packet duplication component 1730 as described with reference to FIG. 17.

At 2515, the method may include transmitting the one or more instances of the first packet using the selected one or more radio link control legs. The operations of 2515 may be performed in accordance with examples as disclosed herein. In some examples, aspects of the operations of 2515 may be performed by a packet duplication component 1730 as described with reference to FIG. 17.

At 2520, the method may include transmitting an indication of the selected one or more radio link control legs in one or more of a PDCP header provided with the first packet, a control packet associated with the first packet, or a duplication medium access control (MAC) control element. The operations of 2520 may be performed in accordance with examples as disclosed herein. In some examples, aspects of the operations of 2520 may be performed by a packet duplication component 1730 as described with reference to FIG. 17.

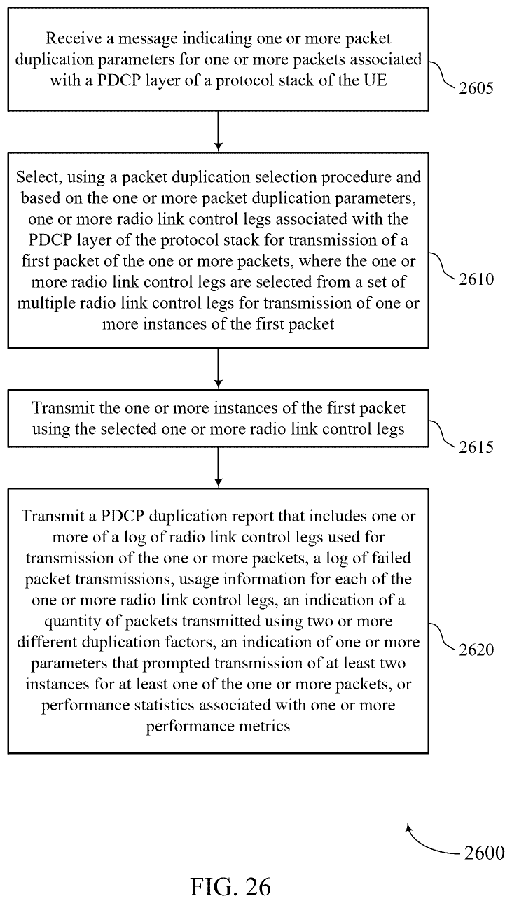

FIG. 26 shows a flowchart illustrating a method 2600 that supports predictive packet duplication for wireless communication in accordance with one or more aspects of the present disclosure. The operations of the method 2600 may be implemented by a UE or its components as described herein. For example, the operations of the method 2600 may be performed by a UE 115 as described with reference to FIGS. 1 through 18. In some examples, a UE may execute a set of instructions to control the functional elements of the UE to perform the described functions. Additionally, or alternatively, the UE may perform aspects of the described functions using special-purpose hardware.

At 2605, the method may include receiving a message indicating one or more packet duplication parameters for one or more packets associated with a packet data convergence protocol (PDCP) layer of a protocol stack of the UE. The operations of 2605 may be performed in accordance with examples as disclosed herein. In some examples, aspects of the operations of 2605 may be performed by a configuration manager 1725 as described with reference to FIG. 17.

At 2610, the method may include selecting, using a packet duplication selection procedure and based on the one or more packet duplication parameters, one or more radio link control legs associated with the PDCP layer of the protocol stack for transmission of a first packet of the one or more packets, where the one or more radio link control legs are selected from a set of multiple radio link control legs for transmission of one or more instances of the first packet. The operations of 2610 may be performed in accordance with examples as disclosed herein. In some examples, aspects of the operations of 2610 may be performed by a packet duplication component 1730 as described with reference to FIG. 17.

At 2615, the method may include transmitting the one or more instances of the first packet using the selected one or more radio link control legs. The operations of 2615 may be performed in accordance with examples as disclosed herein. In some examples, aspects of the operations of 2615 may be performed by a packet duplication component 1730 as described with reference to FIG. 17.

At 2620, the method may include transmitting a PDCP duplication report that includes one or more of a log of radio link control legs used for transmission of the one or more packets, a log of failed packet transmissions, usage information for each of the one or more radio link control legs, an indication of a quantity of packets transmitted using two or more different duplication factors, an indication of one or more parameters that prompted transmission of at least two instances for at least one of the one or more packets, or performance statistics associated with one or more performance metrics. The operations of 2620 may be performed in accordance with examples as disclosed herein. In some examples, aspects of the operations of 2620 may be performed by a duplication report manager 1735 as described with reference to FIG. 17.

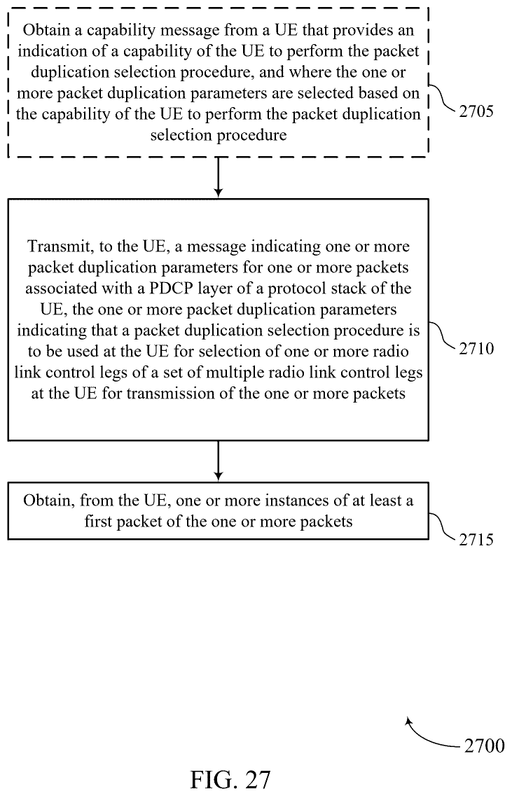

FIG. 27 shows a flowchart illustrating a method 2700 that supports predictive packet duplication for wireless communication in accordance with one or more aspects of the present disclosure. The operations of the method 2700 may be implemented by a network entity or its components as described herein. For example, the operations of the method 2700 may be performed by a network entity as described with reference to FIGS. 1 through 14 and 19 through 22. In some examples, a network entity may execute a set of instructions to control the functional elements of the network entity to perform the described functions. Additionally, or alternatively, the network entity may perform aspects of the described functions using special-purpose hardware.

Optionally, at 2705, the method may include obtaining a capability message from a UE that provides an indication of a capability of the UE to perform the packet duplication selection procedure, and where the one or more packet duplication parameters are selected based on the capability of the UE to perform the packet duplication selection procedure. The operations of 2705 may be performed in accordance with examples as disclosed herein. In some examples, aspects of the operations of 2705 may be performed by a configuration manager 2125 as described with reference to FIG. 21.

At 2710, the method may include transmitting, to the UE, a message indicating one or more packet duplication parameters for one or more packets associated with a packet data convergence protocol (PDCP) layer of a protocol stack of the UE, the one or more packet duplication parameters indicating that a packet duplication selection procedure is to be used at the UE for selection of one or more radio link control legs of a set of multiple radio link control legs at the UE for transmission of the one or more packets. The operations of 2710 may be performed in accordance with examples as disclosed herein. In some examples, aspects of the operations of 2710 may be performed by a configuration manager 2125 as described with reference to FIG. 21.

At 2715, the method may include obtaining, from the UE, one or more instances of at least a first packet of the one or more packets. The operations of 2715 may be performed in accordance with examples as disclosed herein. In some examples, aspects of the operations of 2715 may be performed by a packet duplication component 2130 as described with reference to FIG. 21.

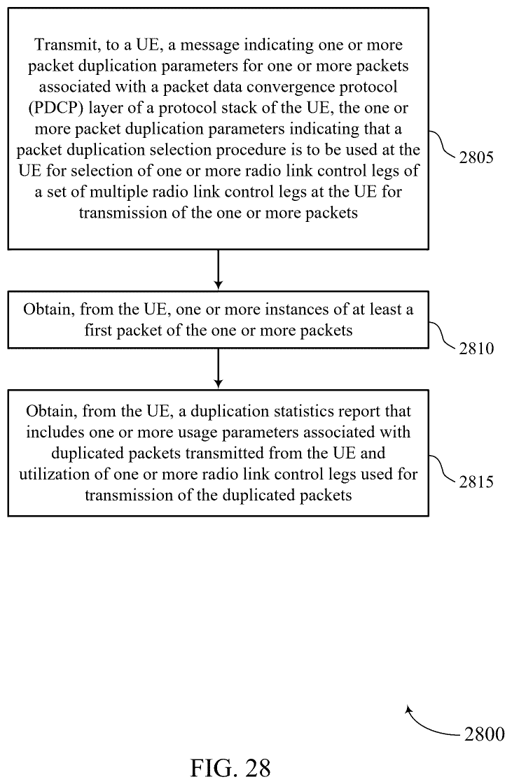

FIG. 28 shows a flowchart illustrating a method 2800 that supports predictive packet duplication for wireless communication in accordance with one or more aspects of the present disclosure. The operations of the method 2800 may be implemented by a network entity or its components as described herein. For example, the operations of the method 2800 may be performed by a network entity as described with reference to FIGS. 1 through 14 and 19 through 22. In some examples, a network entity may execute a set of instructions to control the functional elements of the network entity to perform the described functions. Additionally, or alternatively, the network entity may perform aspects of the described functions using special-purpose hardware.

At 2805, the method may include transmitting, to a UE, a message indicating one or more packet duplication parameters for one or more packets associated with a packet data convergence protocol (PDCP) layer of a protocol stack of the UE, the one or more packet duplication parameters indicating that a packet duplication selection procedure is to be used at the UE for selection of one or more radio link control legs of a set of multiple radio link control legs at the UE for transmission of the one or more packets. The operations of 2805 may be performed in accordance with examples as disclosed herein. In some examples, aspects of the operations of 2805 may be performed by a configuration manager 2125 as described with reference to FIG. 21.

At 2810, the method may include obtaining, from the UE, one or more instances of at least a first packet of the one or more packets. The operations of 2810 may be performed in accordance with examples as disclosed herein. In some examples, aspects of the operations of 2810 may be performed by a packet duplication component 2130 as described with reference to FIG. 21.

At 2815, the method may include obtaining, from the UE, a duplication statistics report that includes one or more usage parameters associated with duplicated packets transmitted from the UE and utilization of one or more radio link control legs used for transmission of the duplicated packets. The operations of 2815 may be performed in accordance with examples as disclosed herein. In some examples, aspects of the operations of 2815 may be performed by a duplication report manager 2135 as described with reference to FIG. 21.

The following provides an overview of aspects of the present disclosure:
Aspect 1: A method for wireless communication at a UE, comprising: receiving a message indicating one or more packet duplication parameters for one or more packets associated with a packet data convergence protocol (PDCP) layer of a protocol stack of the UE; selecting, using a packet duplication selection procedure and based at least in part on the one or more packet duplication parameters, one or more radio link control legs associated with the PDCP layer of the protocol stack for transmission of a first packet of the one or more packets, wherein the one or more radio link control legs are selected from a plurality of radio link control legs for transmission of one or more instances of the first packet; and transmitting the one or more instances of the first packet using the selected one or more radio link control legs.
Aspect 2: The method of aspect 1, wherein the one or more packet duplication parameters include an identification of the plurality of radio link control legs and an indication that the packet duplication selection procedure is to be used at the UE to select the one or more radio link control legs based at least in part on one or more predicted values associated with the one or more packet duplication parameters.
Aspect 3: The method of any of aspects 1 through 2, wherein the one or more packet duplication parameters include one or more performance metrics related to one or more of a predicted error rate associated with the first packet, a predicted latency associated with the first packet, an amount of usage of one or more radio link control legs associated with a duplicated instance of the first packet, or a limit on consecutive errors on the one or more radio link control legs.
Aspect 4: The method of any of aspects 1 through 3, further comprising: transmitting a duplication statistics report that includes one or more usage parameters associated with duplicated packets transmitted from the UE and utilization of one or more radio link control legs used for transmission of the duplicated packets.
Aspect 5: The method of any of aspects 1 through 4, wherein the message further indicates whether packet duplication is enabled or disabled at the UE.
Aspect 6: The method of any of aspects 1 through 5, wherein the one or more radio link control legs include a primary radio link control leg and one or more secondary radio link control legs, and wherein a first instance of the first packet is transmitted on the primary radio link control leg and a second instance of the first packet is transmitted on a first radio link control leg that is selected from the one or more secondary radio link control legs based at least in part on the packet duplication selection procedure that indicates whether to duplicate the first packet, a number of instances of the first packet that are to be transmitted, and which of the one or more secondary radio link control legs to use for duplicate instances of the first packet.
Aspect 7: The method of any of aspects 1 through 6, wherein the packet duplication selection procedure outputs an indication of whether packet duplication of the one or more packets is enabled and an indication of the selected one or more radio link control legs, and wherein the indication is applied to all packets of the one or more packets or is applied on a per-packet basis for each of the one or more packets.
Aspect 8: The method of any of aspects 1 through 7, further comprising: providing, to a prediction model associated with the packet duplication selection procedure, one or more of a channel condition associated with a radio channel used for transmission of the one or more packets, a reliability target associated with the one or more packets, a latency target associated with the one or more packets, a state associated with traffic flow associated with the one or more packets, a state associated with the UE, or a usage limit for at least one of the plurality of radio link control legs.
Aspect 9: The method of any of aspects 1 through 8, wherein the one or more packet duplication parameters include one or more of a latency target associated with the one or more packets, a reliability target associated with the one or more packets, or a throughput target associated with the one or more packets.
Aspect 10: The method of any of aspects 1 through 9, further comprising: transmitting an indication of the selected one or more radio link control legs in one or more of a PDCP header provided with the first packet, a control packet associated with the first packet, or a duplication medium access control (MAC) control element.
Aspect 11: The method of any of aspects 1 through 10, further comprising: transmitting a PDCP duplication report that includes one or more of a log of radio link control legs used for transmission of the one or more packets, a log of failed packet transmissions, usage information for each of the one or more radio link control legs, an indication of a quantity of packets transmitted using two or more different duplication factors, an indication of one or more parameters that prompted transmission of at least two instances for at least one of the one or more packets, or performance statistics associated with one or more performance metrics.
Aspect 12: The method of any of aspects 1 through 11, further comprising: transmitting a capability message that provides an indication of a capability of the UE to perform the packet duplication selection procedure.
Aspect 13: The method of any of aspects 1 through 12, wherein the receiving the message comprises: receiving a radio resource control configuration message that includes one or more key performance indicators (KPIs), performance targets, a link failure threshold parameter associated with the one or more radio link control legs, a usage threshold parameter associated with the one or more radio link control legs, or any combination thereof.
Aspect 14: The method of aspect 13, wherein the radio resource control configuration message further indicates one or more of whether to enable or disable usage of the packet duplication selection procedure, one or more quality of service (QoS) flows on which to enable or disable usage of the packet duplication selection procedure, a loss target over all radio link control legs, a quantity of consecutive errors associated with the one or more radio link control legs, a latency limit across the one or more radio link control legs, or any combination thereof.
Aspect 15: The method of any of aspects 1 through 14, further comprising: initiating a packet duplication fallback procedure based at least in part on a performance metric target associated with the packet duplication selection procedure being unmet, wherein the packet duplication fallback procedure includes one or more of performing packet duplication according to a fallback packet duplication state, transmitting a performance metric violation report as part of performance reporting, or discontinuing use of the packet duplication selection procedure for a radio bearer or packet flow associated with the one or more packets.
Aspect 16: The method of any of aspects 1 through 15, further comprising: receiving a medium access control (MAC) duplication message that indicates a set of radio link control legs to be used to transmit at least a second packet of the one or more packets; and transmitting the second packet using the set of radio link control legs.
Aspect 17: A method for wireless communication at a network entity, comprising: transmitting, to a UE, a message indicating one or more packet duplication parameters for one or more packets associated with a packet data convergence protocol (PDCP) layer of a protocol stack of the UE, the one or more packet duplication parameters indicating that a packet duplication selection procedure is to be used at the UE for selection of one or more radio link control legs of a plurality of radio link control legs at the UE for transmission of the one or more packets; and obtaining, from the UE, one or more instances of at least a first packet of the one or more packets.
Aspect 18: The method of aspect 17, wherein the one or more packet duplication parameters include an identification of the plurality of radio link control legs and an indication that the packet duplication selection procedure is to be used at the UE to select the one or more radio link control legs based at least in part on one or more predicted values associated with the one or more packet duplication parameters.
Aspect 19: The method of any of aspects 17 through 18, wherein the one or more packet duplication parameters include one or more performance metrics related to one or more of a predicted error rate associated with the first packet, a predicted latency associated with the first packet, an amount of usage of one or more radio link control legs associated with a duplicated instance of the first packet, or a limit on consecutive errors on the one or more radio link control legs.
Aspect 20: The method of any of aspects 17 through 19, further comprising: obtaining, from the UE, a duplication statistics report that includes one or more usage parameters associated with duplicated packets transmitted from the UE and utilization of one or more radio link control legs used for transmission of the duplicated packets.
Aspect 21: The method of any of aspects 17 through 20, wherein the message further indicates whether packet duplication is enabled or disabled at the UE.
Aspect 22: The method of any of aspects 17 through 21, wherein the one or more radio link control legs include a primary radio link control leg and one or more secondary radio link control legs, and wherein a first instance of the first packet is transmitted on the primary radio link control leg and a second instance of the first packet is transmitted on a first radio link control leg that is selected from the one or more secondary radio link control legs based at least in part on the packet duplication selection procedure that indicates whether to duplicate the first packet, a number of instances of the first packet that are to be transmitted, and which of the one or more secondary radio link control legs to use for duplicate instances of the first packet.
Aspect 23: The method of any of aspects 17 through 22, wherein the packet duplication parameters configure the packet duplication selection procedure to output an indication of whether packet duplication of the one or more packets is enabled and an indication of the selected one or more radio link control legs, and wherein the indication is applied to all packets of the one or more packets or is applied on a per-packet basis for each of the one or more packets.
Aspect 24: The method of any of aspects 17 through 23, wherein the packet duplication parameters configure a prediction model associated with the packet duplication selection procedure, and wherein inputs to the prediction model include one or more of a channel condition associated with a radio channel used for transmission of the one or more packets, a reliability target associated with the one or more packets, a latency target associated with the one or more packets, a state associated with traffic flow associated with the one or more packets, a state associated with the UE, or a usage limit for at least one of the plurality of radio link control legs.
Aspect 25: The method of any of aspects 17 through 24, further comprising: obtaining an indication from the UE of a quantity of instances of the first packet that are transmitted, wherein the indication is received in one or more of a PDCP header provided with an initial instance the first packet, a control packet associated with the first packet, or a duplication medium access control (MAC) control element.
Aspect 26: The method of any of aspects 17 through 25, further comprising: obtaining a PDCP duplication report from the UE that includes one or more of a log of radio link control legs used for transmission of the one or more packets, a log of failed packet transmissions, usage information for each of the one or more radio link control legs, an indication of a quantity of packets transmitted using two or more different duplication factors, an indication of one or more parameters that prompted transmission of at least two instances for at least one of the one or more packets, or performance statistics associated with one or more performance metrics.
Aspect 27: The method of any of aspects 17 through 26, further comprising: obtaining a capability message from the UE that provides an indication of a capability of the UE to perform the packet duplication selection procedure, and wherein the one or more packet duplication parameters are selected based at least in part on the capability of the UE to perform the packet duplication selection procedure.
Aspect 28: The method of any of aspects 17 through 27, wherein the transmitting the message comprises: outputting a radio resource control configuration message that includes one or more key performance indicators (KPIs), performance targets, a link failure threshold parameter associated with the one or more radio link control legs, a usage threshold parameter associated with the one or more radio link control legs, or any combination thereof.
Aspect 29: The method of any of aspects 17 through 28, further comprising: configuring the UE with a packet duplication fallback procedure that is to be initiated based at least in part on a performance metric target associated with the packet duplication selection procedure being unmet, wherein the packet duplication fallback procedure includes one or more of performing packet duplication according to a fallback packet duplication state, transmitting a performance metric violation report as part of performance reporting, or discontinuing use of the packet duplication selection procedure for a radio bearer or packet flow associated with the one or more packets.
Aspect 30: The method of any of aspects 17 through 29, further comprising: outputting a medium access control (MAC) duplication message to the UE that indicates a set of radio link control legs to be used to transmit at least a second packet of the one or more packets; and obtaining one or more instances of the second packet in accordance with the MAC duplication message.
Aspect 31: A UE for wireless communication, comprising one or more memories storing processor-executable code, and one or more processors coupled with the one or more memories and individually or collectively operable to execute the code to cause the UE to perform a method of any of aspects 1 through 16.
Aspect 32: A UE for wireless communication, comprising at least one means for performing a method of any of aspects 1 through 16.
Aspect 33: A non-transitory computer-readable medium storing code for wireless communication, the code comprising instructions executable by one or more processors to perform a method of any of aspects 1 through 16.
Aspect 34: A network entity for wireless communication, comprising one or more memories storing processor-executable code, and one or more processors coupled with the one or more memories and individually or collectively operable to execute the code to cause the network entity to perform a method of any of aspects 17 through 30.
Aspect 35: A network entity for wireless communication, comprising at least one means for performing a method of any of aspects 17 through 30.
Aspect 36: A non-transitory computer-readable medium storing code for wireless communication, the code comprising instructions executable by one or more processors to perform a method of any of aspects 17 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a message indicating one or more packet duplication parameters for one or more packets associated with a packet data convergence protocol (PDCP) layer of a protocol stack of the UE;
select, using a packet duplication selection procedure and based at least in part on the one or more packet duplication parameters, one or more radio link control legs associated with the PDCP layer of the protocol stack for transmission of a first packet of the one or more packets, wherein the one or more radio link control legs are selected from a plurality of radio link control legs for transmission of one or more instances of the first packet; and
transmit the one or more instances of the first packet using the selected one or more radio link control legs.

2. The UE of claim 1, wherein the one or more packet duplication parameters include an identification of the plurality of radio link control legs and an indication that the packet duplication selection procedure is to be used at the UE to select the one or more radio link control legs based at least in part on one or more predicted values associated with the one or more packet duplication parameters.

3. The UE of claim 1, wherein the one or more packet duplication parameters include one or more performance metrics related to one or more of a predicted error rate associated with the first packet, a predicted latency associated with the first packet, an amount of usage of one or more radio link control legs associated with a duplicated instance of the first packet, or a limit on consecutive errors on the one or more radio link control legs.

4. The UE of claim 1, wherein the one or more processors are individually or collectively further operable to execute the code to cause the UE to:
transmit a duplication statistics report that includes one or more usage parameters associated with duplicated packets transmitted from the UE and utilization of one or more radio link control legs used for transmission of the duplicated packets.

5. The UE of claim 1, wherein the message further indicates whether packet duplication is enabled or disabled at the UE.

6. The UE of claim 1, wherein the one or more radio link control legs include a primary radio link control leg and one or more secondary radio link control legs, and wherein a first instance of the first packet is transmitted on the primary radio link control leg and a second instance of the first packet is transmitted on a first radio link control leg that is selected from the one or more secondary radio link control legs based at least in part on the packet duplication selection procedure that indicates whether to duplicate the first packet, a number of instances of the first packet that are to be transmitted, and which of the one or more secondary radio link control legs to use for duplicate instances of the first packet.

7. The UE of claim 1, wherein the packet duplication selection procedure outputs an indication of whether packet duplication of the one or more packets is enabled and an indication of the selected one or more radio link control legs, and wherein the indication is applied to all packets of the one or more packets or is applied on a per-packet basis for each of the one or more packets.

8. The UE of claim 1, wherein the one or more processors are individually or collectively further operable to execute the code to cause the UE to:
provide, to a prediction model associated with the packet duplication selection procedure, one or more of a channel condition associated with a radio channel used for transmission of the one or more packets, a reliability target associated with the one or more packets, a latency target associated with the one or more packets, a state associated with traffic flow associated with the one or more packets, a state associated with the UE, or a usage limit for at least one of the plurality of radio link control legs.

9. The UE of claim 1, wherein the one or more packet duplication parameters include one or more of a latency target associated with the one or more packets, a reliability target associated with the one or more packets, or a throughput target associated with the one or more packets.

10. The UE of claim 1, wherein the one or more processors are individually or collectively further operable to execute the code to cause the UE to:
transmit an indication of the selected one or more radio link control legs in one or more of a PDCP header provided with the first packet, a control packet associated with the first packet, or a duplication medium access control (MAC) control element.

11. The UE of claim 1, wherein the one or more processors are individually or collectively further operable to execute the code to cause the UE to:
transmit a PDCP duplication report that includes one or more of a log of radio link control legs used for transmission of the one or more packets, a log of failed packet transmissions, usage information for each of the one or more radio link control legs, an indication of a quantity of packets transmitted using two or more different duplication factors, an indication of one or more parameters that prompted transmission of at least two instances for at least one of the one or more packets, or performance statistics associated with one or more performance metrics.

12. The UE of claim 1, wherein the one or more processors are individually or collectively further operable to execute the code to cause the UE to:
transmit a capability message that provides an indication of a capability of the UE to perform the packet duplication selection procedure.

13. The UE of claim 1, wherein, to receive the message, the one or more processors are individually or collectively operable to execute the code to cause the UE to:
receive a radio resource control configuration message that includes one or more key performance indicators (KPIs), performance targets, a link failure threshold parameter associated with the one or more radio link control legs, a usage threshold parameter associated with the one or more radio link control legs, or any combination thereof.

14. The UE of claim 13, wherein the radio resource control configuration message further indicates one or more of whether to enable or disable usage of the packet duplication selection procedure, one or more quality of service (QoS) flows on which to enable or disable usage of the packet duplication selection procedure, a loss target over all radio link control legs, a quantity of consecutive errors associated with the one or more radio link control legs, a latency limit across the one or more radio link control legs, or any combination thereof.

15. The UE of claim 1, wherein the one or more processors are individually or collectively further operable to execute the code to cause the UE to:
initiate a packet duplication fallback procedure based at least in part on a performance metric target associated with the packet duplication selection procedure being unmet, wherein the packet duplication fallback procedure includes one or more of performing packet duplication according to a fallback packet duplication state, transmitting a performance metric violation report as part of performance reporting, or discontinuing use of the packet duplication selection procedure for a radio bearer or packet flow associated with the one or more packets.

16. The UE of claim 1, wherein the one or more processors are individually or collectively further operable to execute the code to cause the UE to:
receive a medium access control (MAC) duplication message that indicates a set of radio link control legs to be used to transmit at least a second packet of the one or more packets; and
transmit the second packet using the set of radio link control legs.

17. A network entity, comprising:
one or more memories storing processor-executable code; and
one or more processors coupled with the one or more memories and individually or collectively operable to execute the code to cause the network entity to:
transmit, to a user equipment (UE), a message indicating one or more packet duplication parameters for one or more packets associated with a packet data convergence protocol (PDCP) layer of a protocol stack of the UE, the one or more packet duplication parameters indicating that a packet duplication selection procedure is to be used at the UE for selection of one or more radio link control legs of a plurality of radio link control legs at the UE for transmission of the one or more packets; and
obtain, from the UE, one or more instances of at least a first packet of the one or more packets.

18. The network entity of claim 17, wherein the one or more packet duplication parameters include an identification of the plurality of radio link control legs and an indication that the packet duplication selection procedure is to be used at the UE to select the one or more radio link control legs based at least in part on one or more predicted values associated with the one or more packet duplication parameters.

19. The network entity of claim 17, wherein the one or more packet duplication parameters include one or more performance metrics related to one or more of a predicted error rate associated with the first packet, a predicted latency associated with the first packet, an amount of usage of one or more radio link control legs associated with a duplicated instance of the first packet, or a limit on consecutive errors on the one or more radio link control legs.

20. A method for wireless communication at a user equipment (UE), comprising:
receiving a message indicating one or more packet duplication parameters for one or more packets associated with a packet data convergence protocol (PDCP) layer of a protocol stack of the UE;
selecting, using a packet duplication selection procedure and based at least in part on the one or more packet duplication parameters, one or more radio link control legs associated with the PDCP layer of the protocol stack for transmission of a first packet of the one or more packets, wherein the one or more radio link control legs are selected from a plurality of radio link control legs for transmission of one or more instances of the first packet; and
transmitting the one or more instances of the first packet using the selected one or more radio link control legs.
